(19) United States
(12) Patent Application Publication
(10) Pub. No.: US 2021/0345652 A1
(43) Pub. Date: Nov. 11, 2021

(54) PEANUT FLAVOR COMPOSITIONS AND FOOD PRODUCTS CONTAINING THE SAME

(71) Applicant: MARS, INCORPORATED, McLean, VA (US)

(72) Inventors: John Didzbalis, Hackettstown, NJ (US); Johanna Sprenger, Freising (DE); Peter Schieberle, Freising (DE)

(73) Assignee: MARS, INCORPORATED, McLean, VA (US)

(21) Appl. No.: 17/282,544

(22) PCT Filed: Oct. 4, 2019
(86) PCT No.: PCT/US2019/054792

§ 371 Date: Apr. 2, 2021

Related U.S. Application Data
(60) Provisional application No. 62/741,407, filed on Oct. 4, 2018.

(51) Int. Cl. A23L 27/20; A23L 27/00; A23K 20/121; A23K 20/132; A23K 20/105

(52) U.S. Cl. CPC A23L 27/2054; A23L 27/2028; A23L 27/2052; A23L 27/2022; A23K 20/121; A23K 20/132; A23K 20/105; A23L 27/88

(57) ABSTRACT

The presently disclosed subject matter provides a flavor composition that can provide and/or enhances a peanut flavor. In certain embodiments, the flavor composition comprises aroma compounds that contribute to a peanut flavor. Also provided herein are methods of producing a food product and/or enhancing a roasted peanut flavor of a food product using the compounds and/or flavor compositions disclosed herein.

### CROSS-REFERENCE TO RELATED APPLICATIONS

This application claims priority to U.S. Provisional Application Ser. No. 62/741,407 filed on Oct. 4, 2018, which is incorporated in its entirety herein.

### FIELD

The presently disclosed subject matter relates to flavor compositions containing compounds found in peanuts. The flavor compositions can include combinations of compounds and can be added to food products by various delivery systems to enhance peanut flavoring.

### BACKGROUND

Flavors play a critical role in the appreciation of food and beverage products. Roasted peanuts impart a specific flavor and can be used in many food products, such as peanut butter, confectioneries or bakery products. The aroma of raw and roasted peanuts has been an investigation topic for more than 50 years. More than 200 volatile compounds have been identified in roasted peanuts by means of instrumental analytical methods. However, such investigations have not examined the contribution of single aroma compounds to the overall peanut flavor. Thus, there remains a need in the art for further identification of the aroma compounds that provide an overall peanut flavor.

### SUMMARY OF THE INVENTION

The presently disclosed subject matter is directed to flavor compositions and methods for making and modifying such compositions across a variety of food products. Specifically, the present disclosed subject matter provides a flavor composition comprising: a first aroma compound selected from the group consisting of 2-acetyl-(1,4,5,6)-tetrahydropyridine, 2-acetyl-(3,4,5,6)-tetrahydropyridine, 2-acetyl-1-pyrroline, 2-propionyl-1-pyrroline, 2-acetylpyrazine and any combination thereof; a second aroma compound selected from the group consisting of 2,3-pentanedione, 2,3-butanedione and a combination thereof; and a third aroma compound selected from the group consisting of phenylacetaldehyde, phenylacetic acid and a combination thereof.

In certain embodiments, the concentration ratio of the first compound to the second compound to the third compound is a:b:c, wherein a ranges from about 3 to about 8, b ranges from about 20 to about 60, and c ranges from about 10 to about 60.

In certain embodiments, the flavor composition further comprises: a fourth aroma compound of 4-hydroxy-2,5-dimethyl-3(2H)-furanone; a fifth aroma compound selected from the group consisting of 2-methylbutanal, 3-methylbutanal and a combination thereof; a sixth aroma compound selected from the group consisting of 2-ethyl-3,5-dimethylpyrazine, 2,3-diethyl-5-methylpyrazine and a combination thereof; a seventh aroma compound of 2-methoxy-4-vinylphenol; and/or an eighth aroma compound selected from the group consisting of hydrogen sulfide, methanethiol, dimethyl trisulfide, methylpropanal and any combination thereof.

In certain embodiments, the concentration ratio of the first compound to the fourth compound to the fifth compound to the sixth compound to the seventh compound to the eighth compound is a:d:ef:g:h, wherein a ranges from about 0.1 to about 10, d ranges from about 10 to about 40, e ranges from about 20 to about 90, f ranges from about 1 to about 10, g ranges from about 10 to about 40, and h ranges from about 50 to about 130.

The presently disclosed subject matter further provides a flavor composition comprising hydrogen sulfide, methanethiol, dimethyl trisulfide, and/or methylpropanal.

In certain embodiments, the concentration ratio of hydrogen sulfide, methanethiol, dimethyl trisulfide, methylpropanal is w:x:y:z, wherein w ranges from about 50 to about 100, x ranges from about 5 to about 20, y ranges from about 5 to about 20, and z ranges from about 30 to about 50.

In certain embodiments, the flavor composition further comprises one or more aroma compounds selected from the group consisting of 2,3-butanedione, methanethiol, 2-acetyl-1-pyrroline, 2-furfurylthiol, 2,3-pentanedione, 2-acetyl-(1,4,5,6)-tetrahydropyridine, 2-propionyl-1-pyrroline, 2-isopropyl-3-methoxypyrazine, dimethyl tri sulfide, methylpropanal, 2-ethyl-3,5-dimethylpyrazine, 2-acetyl-(3,4,5,6)-tetrahydropyridine, phenylacetaldehyde, 2-methylbutanal, 3-methylbutanal, 2-isobutyl-3-methoxypyrazine, 3-(methylthio)-propanal, 4-hydroxy-2,5-dimethyl-3(2H)-furanone, hydrogen sulfide, acetic acid, 3-hydroxy-4,5-dimethyl-2(5H)-furanone, phenylacetic acid, 2-methoxy-4-vinylphenol, 2,3-diethyl-5-methylpyrazine, 1-octanol, 2-(sec-butyl)-3-methoxypyrazine, 2-methoxpyhenol, 2-acetylpyrazine, 2,3,5-trimethylpyrazine, 3-methylbutanoic acid, nonanal, octanal, 2-methylbutanoic acid, (Z)-2-nonenal, hexanal, hexanoic acid and pentanoic acid.

The presently disclosed subject matter further provides a flavor composition comprising one or more compound selected from the group consisting of 2,3-butanedione, methanethiol, 2-acetyl-1-pyrroline, 2-furfurylthiol, 2,3-pentanedione, 2-acetyl-(1,4,5,6)-tetrahydropyridine, 2-propionyl-1-pyrroline, 2-isopropyl-3-methoxypyrazine, dimethyl trisulfide, methylpropanal, 2-ethyl-3,5-dimethylpyrazine, 2-acetyl-(3,4,5,6)-tetrahydropyridine, phenylacetaldehyde, 2-methylbutanal, 3-methylbutanal, 2-isobutyl-3-methoxypyrazine, 3-(methylthio)-propanal, 4-hydroxy-2,5-dimethyl-3(2H)-furanone, hydrogen sulfide, acetic acid, 3-hydroxy-4,5-dimethyl-2(5H)-furanone, phenylacetic acid, 2-methoxy-4-vinyl phenol, 2,3-diethyl-5-methylpyrazine, 1-octanol, 2-(sec-butyl)-3-methoxypyrazine, 2-methoxpyhenol, 2-acetylpyrazine, 2,3,5-trimethylpyrazine, 3-methylbutanoic acid, nonanal, octanal, 2-methylbutanoic acid and (Z)-2-nonenal. In certain embodiments, the one or more compound has an odor activity value (OAV) of no less than 1 in freshly roasted peanuts. In certain embodiments, the one or more compound is 2,3-butanedione, methanethiol, 2-acetyl-1-pyrroline, 2-furfurylthiol, 2,3-pentanedione, 2-acetyl-(1,4,5,6)-tetrahydropyridine, 2-propionyl-1-pyrroline, 2-isopropyl-3-methoxypyrazine, dimethyl trisulfide, methylpropanal, 2-ethyl-3,5-dimethylpyrazine, 2-acetyl-(3,4,5,6)-tetrahydropyridine, phenylacetaldehyde, 2-methylbutanal, 3-methylbutanal, 2-isobutyl-3-methoxypyrazine, 3-(methylthio)-propanal, and/or 4-hydroxy-2,5-dimethyl-3(2H)-furanone. In certain embodiments, the one or more compound has an OAV of no less than 100 in freshly roasted peanuts. In certain embodiments, the one or more compound is 2,3-butanedione, methanethiol, 2-acetyl-1-pyrroline, 2-furfurylthiol, 2,3-pentanedione, 2-acetyl-(1,4,5,6)-tetrahydropyridine, 2-propionyl-1-pyrroline, and/or 2-isopropyl-3-methoxypyrazine. In certain embodiments, the one or more compound has an OAV of no less than 500 in freshly roasted peanuts.

In certain embodiments, the composition further comprises an edible carrier. In certain embodiments, the aroma compounds are present at a total concentration of from about 0.0001% to about 20% w/w in the flavor composition. In certain embodiments, the aroma compounds are present at a total concentration of from about 1 μM to about 100 mM in the flavor composition. In certain embodiments, the aroma compounds are present at a total concentration of from about 0.01 ppm to 1,000 ppm in the flavor composition.

In certain embodiments, the edible carrier is a water/oil mixture. In certain embodiments, the flavor composition enhances a roasted peanut flavor.

The presently disclosed subject matter further provides food product comprising a base food and any flavor composition disclosed herein. In certain embodiments, the flavor composition is present at a concentration of from about 0.01 ppb to 1,000 ppb in the food product. In certain embodiments, the flavor composition is present at a concentration of from about 0.01 ppm to 1,000 ppm in the food product. In certain embodiments, the flavor composition is present at a concentration of from about 0.0001% to about 1% w/w in the food product.

In certain embodiments, the base food comprises a peanut, e.g., a high oleic acid peanut (HOAP) or a low oleic acid peanut (LOAP). In certain embodiments, the food product is a human food or a pet food.

The presently disclosed subject matter provides a method of producing a food product, comprising admixing a base food with an effective amount of any flavor composition disclosed herein. The presently disclosed subject matter further provides a method of enhancing a roasted peanut flavor of a food product, comprising admixing a food product with an effective amount of any flavor composition disclosed herein.

### BRIEF DESCRIPTION OF THE DRAWINGS

FIG. 1 depicts an aroma profile analysis of freshly roasted high oleic acid peanuts (HOAP) and a reconstituted aroma model.

FIG. 2 depicts an aroma profile analysis of freshly roasted and 5 days stored peanuts.

FIG. 3 depicts an aroma profile analysis of freshly roasted and 3 months stored peanuts.

FIG. 4 depicts an aroma profile analysis of freshly roasted and 6 months stored roasted peanuts.

FIG. 5 depicts an aroma profile analysis of freshly roasted and 1 year stored roasted peanuts.

FIG. 6 depicts an aroma recombination of freshly roasted low oleic acid peanuts and the aroma model.

FIG. 7 depicts an aroma profile analysis of freshly roasted and 6 months stored roasted low oleic acid peanuts (LOAP).

FIG. 8 depicts an aroma profile analysis of freshly roasted HOAP and LOAP.

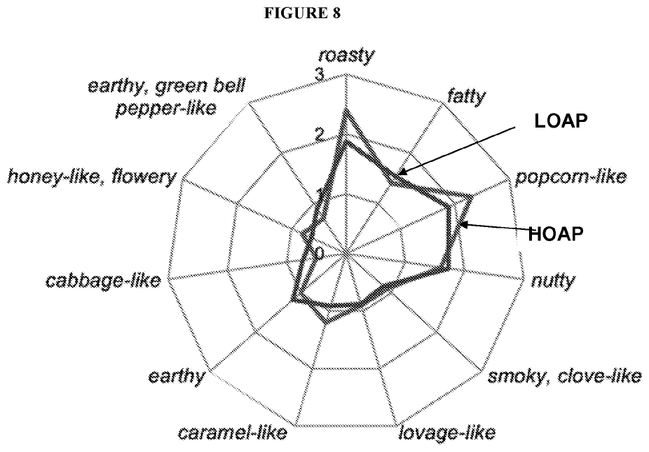

### DETAILED DESCRIPTION

To date, there remains a need for a flavor composition that can provide and/or enhance a peanut flavor. In one aspect, this presently disclosed subject matter provides a flavor composition that has a peanut flavor and/or peanut aroma. This flavor composition can be added to food products in order to provide or enhance a peanut flavor. This is especially useful given that it allows a consumer to enjoy food products that have peanut flavor or aroma but without ingesting actual peanuts. The flavor compositions can be used to enhance a peanut flavor of a food product. Also provided herein are methods of producing a food product and/or enhancing a roasted peanut flavor of a food product using the compounds and/or flavor compositions disclosed herein.

### 1. Definitions

The terms used in this specification generally have their ordinary meanings in the art, within the context of this invention and in the specific context where each term is used. Certain terms are discussed below, or elsewhere in the specification, to provide additional guidance to the practitioner in describing the compositions and methods of the invention and how to make and use them.

As used herein, the use of the word “a” or “an” when used in conjunction with the term “comprising” in the claims and/or the specification can mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

As used herein, “taste” refers to a sensation caused by activation or inhibition of receptor cells in a subject's taste buds. In certain embodiments, taste can be selected from the group consisting of sweet, sour, salt, bitter, kokumi and umami. In certain embodiments, a taste is elicited in a subject by a “tastant.” In certain embodiments, a tastant is a synthetic tastant. In certain embodiments, the tastant is prepared from a natural source.

As used herein, “taste profile” refers to a combination of tastes, such as, for example, one or more of a sweet, sour, salt, bitter, umami, kokumi and free fatty acid taste. In certain embodiments, a taste profile is produced by one or more tastant that is present in a composition at the same or different concentrations. In certain embodiments, a taste profile refers to the intensity of a taste or combination of tastes, for example, a sweet, sour, salt, bitter, umami, kokumi and free fatty acid taste, as detected by a subject or any assay known in the art. In certain embodiments, modifying, changing or varying the combination of tastants in a taste profile can change the sensory experience of a subject.

As used herein, “flavor” refers to one or more sensory stimuli, such as, for example, one or more of taste (gustatory), smell (olfactory), touch (tactile) and temperature (thermal) stimuli. In certain non-limiting embodiments, the sensory experience of a subject exposed to a flavor can be classified as a characteristic experience for the particular flavor. For example, a flavor can be identified by the subject as being, but not limited to, a peanut, roasted peanut, floral, citrus, berry, nutty, caramel, chocolate, peppery, smoky, cheesy, meaty, etc., flavor. As used herein, a flavor composition can be selected from a liquid, solution, dry powder, spray, paste, suspension and any combination thereof. The flavor can be a natural composition, an artificial composition, a nature identical, or any combination thereof.

As used interchangeably herein, “aroma” and “smell” refer to an olfactory response to a stimulus. For example, and not by way of limitation, an aroma can be produced by aromatic substances that are perceived by the odor receptors of the olfactory system.

As used herein, “flavor profile” refers to a combination of sensory stimuli, for example, tastes, and/or olfactory, tactile and/or thermal stimuli. In certain embodiments, the flavor profile comprises one or more flavors which contribute to the sensory experience of a subject. In certain embodiments, modifying, changing or varying the combination of stimuli in a flavor profile can change the sensory experience of a subject.

As used herein “admixing,” for example, “admixing the flavor composition or combinations thereof of the present application with a food product,” refers to the process where the flavor composition, or individual components of the flavor composition, is mixed with or added to the completed product or mixed with some or all of the components of the product during product formation or some combination of these steps. When used in the context of admixing, the term “product” refers to the product or any of its components. This admixing step can include a process selected from the step of adding the flavor composition to the product, spraying the flavor composition on the product, coating the flavor composition on the product, suspending the product in the flavor composition, painting the flavor composition on the product, pasting the flavor composition on the product, encapsulating the product with the flavor composition, mixing the flavor composition with the product and any combination thereof. The flavor composition can be a liquid, emulsion, dry powder, spray, paste, suspension and any combination thereof.

In certain embodiments, the compounds of a flavor composition can be generated during the processing of a food product, e.g., sterilization, retorting and/or extrusion, from precursor compounds present in the food product. In certain embodiments, a compound of a flavor composition can be generated during the processing of a food product and additional components of the flavor composition can be added to the food product by admixing.

As used herein, “ppm” means parts-per-million and is a weight relative parameter. A part-per-million is a microgram per gram, such that a component that is present at 10 ppm is present at 10 micrograms of the specific component per 1 gram of the aggregate mixture.

As used herein, “ppb” means parts-per-billion and is a weight relative parameter. A part-per-billion is a microgram per kilogram, such that a component that is present at 10 ppb is present at 10 micrograms of the specific component per 1 kilogram of the aggregate mixture.

As used herein “food product” refers to an ingestible product, such as, but not limited to, human food, animal (pet) foods, and pharmaceutical compositions.

The term “pet food” or “pet food product” means a product or composition that is intended for consumption by a companion animal, such as cats, dogs, guinea pigs, rabbits, birds and horses. For example, but not by way of limitation, the companion animal can be a “domestic” cat such as Felis domesticus. In certain embodiments, the companion animal can be a “domestic” dog, e.g., Canis lupus familiaris. A “pet food” or “pet food product” includes any food, feed, snack, food supplement, liquid, beverage, treat, toy (chewable and/or consumable toys), and meal substitute or meal replacement.

As used herein “nutritionally-complete” refers to food product that contains all known required nutrients for the intended recipient of the food product, in appropriate amounts and proportions based, for example, on recommendations of recognized or competent authorities in the field of companion animal nutrition. Such foods are therefore capable of serving as a sole source of dietary intake to maintain life, without the addition of supplemental nutritional sources.

As used herein “flavor composition” refers to at least one compound or biologically acceptable salt thereof that modulates, including enhancing, multiplying, potentiating, decreasing, suppressing, or inducing, the tastes, smells, flavors and/or textures of a natural or synthetic tastant, flavoring agent, taste profile, flavor profile and/or texture profile in an animal or a human. In certain embodiments, the flavor composition comprises a combination of compounds or biologically acceptable salts thereof. In certain embodiments, the flavor composition includes one or more excipients.

### 2. Peanut Aroma Compounds

The presently disclosed subject matter provides aroma compounds that contribute to a peanut flavor. In certain embodiments, the peanut flavor and/or aroma is a roasted peanut flavor and/or aroma. In certain embodiments, the compound can be acetic acid, hydrogen sulfide, phenylacetaldehyde, 2-methylbutanal, methylpropanal, 4-hydroxy-2,5-dimethyl-3(2H)-furanone, 2,3-pentanedione, 2,3-butanedione, 2-methoxy-4-vinylphenol, 3-methylbutanal, nonanal, decanoic acid, 2,3,5-trimethylpyrazine, methanethiol, 2,5-dimethylpyrazine, (E,Z)-2,4-nonadienal, phenylacetic acid, furfurylalcohol, octanal, 2-ethyl-3,5-dimethylpyrazine, 1-octanol, furfural, hexanoic acid, 2,3-dimethylpyrazine, (E)-2-undecenal, 2-acetyl-(3,4,5,6)-tetrahydropyridine, 2-acetyl-(1,4,5,6)-tetrahydropyridine, (E)-2-decenal, 2-acetylpyrazine, 2,3-diethyl-5-methylpyrazine, 2-phenylethanol, 2-methylbutanoic acid, 4-hydroxy-3-methoxy-benzaldehyde, hexanal, 3-(methylthio)-propanal, 3-methylbutanoic acid, 3-ethyl-2,5-dimethylpyrazine, 2-acetyl-1-pyrroline, pentanoic acid, 2-propionyl-1-pyrroline, 2-methoxpyhenol, (Z)-2-decenal, 2-acetylpyridine, 3-hydroxy-4,5-dimethyl-2(5H)-furanone, 2-furfurylthiol, (E)-2-nonenal, dimethyl trisulfide, 6-nonalactone, 2-(sec-butyl)-3-methoxypyrazine, 2-isobutyl-3-methoxypyrazine, 2-isopropyl-3-methoxypyrazine, (Z)-2-nonenal, 1-octen-3-one, any derivative or analog thereof, or any combination thereof. In certain embodiments, the compound can be any compound listed in Tables 1-18 of Examples 1 and 2, any derivative or analog thereof, or any combination thereof.

In certain embodiments, the peanut flavor and/or aroma is a high oleic acid peanut (HOAP) flavor and/or aroma. In certain embodiments, the compound is a highly volatile compound selected from the group consisting of hydrogen sulfide, methanethiol, dimethyl sulfide, methylpropanal, any derivative or analogy thereof or any combination thereof. In certain embodiments, the compound can be acetic acid, hydrogen sulfide, phenylacetaldehyde, 2-methylbutanal, methylpropanal, 4-hydroxy-2,5-dimethyl-3 (2H)-furanone, 2,3-pentanedione, 2,3-butanedione, 2-methoxy-4-vinylphenol, 3-methylbutanal, nonanal, decanoic acid, 2,3,5-trimethylpyrazine, methanethiol, 2,5-dimethylpyrazine, (E,Z)-2,4-nonadienal, phenylacetic acid, furfurylalcohol, octanal, 2-ethyl-3,5-dimethylpyrazine, 1-octanol, furfural, hexanoic acid, 2,3-dimethylpyrazine, (E)-2-undecenal, 2-acetyl-(3,4,5,6)-tetrahydropyridine, 2-acetyl-(1,4,5,6)-tetrahydropyridine, (E)-2-decenal, 2-acetylpyrazine, 2,3-diethyl-5-methylpyrazine, 2-phenylethanol, 2-methylbutanoic acid, 4-hydroxy-3-methoxy-benzaldehyde, hexanal, 3-(methylthio)-propanal, 3-methylbutanoic acid, 3-ethyl-2,5-dimethylpyrazine, 2-acetyl-1-pyrroline, pentanoic acid, 2-propionyl-1-pyrroline, 2-methoxpyhenol, (Z)-2-decenal, 2-acetylpyridine, 3-hydroxy-4,5-dimethyl-2(5H)-furanone, 2-furfurylthiol, (E)-2-nonenal, dimethyl trisulfide, 6-nonalactone, 2-(sec-butyl)-3-methoxypyrazine, 2-isobutyl-3-methoxypyrazine, 2-isopropyl-3-methoxypyrazine, (Z)-2-nonenal, 1-octen-3-one, any derivative or analog thereof, or any combination thereof.

In certain embodiments, the compound can be 2,3-butanedione, methanethiol, 2-acetyl-1-pyrroline, 2-furfurylthiol, 2,3-pentanedione, 2-acetyl-(1,4,5,6)-tetrahydropyridine, 2-propionyl-1-pyrroline, 2-isopropyl-3-methoxypyrazine, dimethyl trisulfide, methylpropanal, 2-ethyl-3,5-dimethylpyrazine, 2-acetyl-(3,4,5,6)-tetrahydropyridine, phenylacetaldehyde, 2-methylbutanal, 3-methylbutanal, 2-isobutyl-3-methoxypyrazine, 3-(methylthio)-propanal, 4-hydroxy-2,5-dimethyl-3 (2H)-furanone, hydrogen sulfide, acetic acid, 3-hydroxy-4,5-dimethyl-2(5H)-furanone, phenylacetic acid, 2-methoxy-4-vinylphenol, 2,3-diethyl-5-methylpyrazine, 1-octanol, 2-(sec-butyl)-3-methoxypyrazine, 2-methoxpyhenol, 2-acetylpyrazine, 2,3,5-trimethylpyrazine, 3-methylbutanoic acid, nonanal, octanal, 2-methylbutanoic acid, (Z)-2-nonenal, any derivative or analog thereof, or any combination thereof, wherein the odor activity value of the compound is above 1.

In certain embodiments, the peanut is a low oleic acid peanut (LOAP). In certain embodiments, the compound can be acetic acid, hydrogen sulfide, 2-methoxy-4-vinylphenol, phenylacetaldehyde, 4-hydroxy-2,5-dimethyl-3 (2H)-furanone, 2-methylbutanal, methylpropanal, nonanal, 2,3-pentanedione, 3-methylbutanal, 2,3,5-trimethylpyrazine, phenylacetic acid, 1-octanol, hexanoic acid, methanethiol, octanal, hexanal, furfurylalcohol, (E)-2-undecenal, furfural, 2-ethyl-3,5-dimethylpyrazine, 2-methylbutanoic acid, 3-methylbutanoic acid, 2,3-diethyl-5-methylpyrazine, 2-acetylpyrazine, 2-acetyl-(1,4,5,6)-tetrahydropyridine, 2,3-butanedione, pentanoic acid, 3-(methylthio)-propanal, 2-acetyl-1-pyrroline, 2-propionyl-1-pyrroline, 2-methoxpyhenol, (Z)-2-nonenal, 1-octen-3-one, 3-hydroxy-4,5-dimethyl-2(5H)-furanone, 2-furfurylthiol, 2-acetyl-(3,4,5,6)-tetrahydropyridine, 2-isopropyl-3-methoxypyrazine, 2-isobutyl-3-methoxypyrazine, 2-(sec-butyl)-3-methoxypyrazine, dimethyl trisulfide, any derivative or analog thereof, or any combination thereof. In certain embodiments, the compound is a highly volatile compound selected from the group consisting of hydrogen sulfide, methanethiol, methylpropanal, any derivative or analogy thereof or any combination thereof. In certain embodiments, the compound can be methanethiol, 2-isopropyl-3-methoxypyrazine, 2-acetyl-1-pyrroline, 2-furfurylthiol, 2-propionyl-1-pyrroline, 2-acetyl-(1,4,5,6)-tetrahydropyridine, 2,3-pentanedione, methylpropanal, 2-isobutyl-3-methoxypyrazine, dimethyl trisulfide, 3-(methylthio)-propanal, phenylacetaldehyde, 2,3-butanedione, 4-hydroxy-2,5-dimethyl-3 (2H)-furanone, 2-ethyl-3,5-dimethylpyrazine, 2-methylbutanal, 3-methylbutanal, acetic acid, hydrogen sulfide, 3-hydroxy-4,5-dimethyl-2(5H)-furanone, 2-methoxy-4-vinylphenol, 1-octanol, phenylacetic acid, 2,3-diethyl-5-methylpyrazine, 2-methoxpyhenol, 3-methylbutanoic acid, 2-(sec-butyl)-3-methoxypyrazine, 2-acetylpyrazine, 2-acetyl-(3,4,5,6)-tetrahydropyridine, (Z)-2-nonenal, 2,3,5-trimethylpyrazine, octanal, hexanal, 2-methylbutanoic acid, nonanal, hexanoic acid, any derivative or analog thereof, or any combination thereof, wherein the odor activity value of the compound is above 1.

In certain embodiments, the compound can be 2-acetyl-(3,4,5,6)-tetrahydropyridine, 2,3-pentanedione, phenylacetaldehyde, 2-acetyl-(1,4,5,6)-tetrahydropyridine, 4-hydroxy-2,5-dimethyl-3(2H)-furanone, 2-methylbutanal, 2,3-butanedione, 3-methylbutanal, 2-acetyl-1-pyrroline, 2-ethyl-3,5-dimethylpyrazine, 2-methoxy-4-vinylphenol, 2,3-diethyl-5-methylpyrazine, phenylacetic acid, 2-propionyl-1-pyrroline, 2-acetylpyrazine, hydrogen sulfide, methanethiol, dimethyl trisulfide, any derivative or analog thereof, or any combination thereof. In certain embodiments, the compound of the present disclosure can comprise a salt of the any compound disclosed herein, for example, but not limited to, an acetate salt or a formate salt. In certain embodiments, the salt comprises an anion (−) (for example, but not limited to, Cl⁻, O²⁻, CO₃²⁻, HCO₃⁻, OH⁻, NO₃⁻, PO₄³⁻, SO₄²⁻, CH₃COO⁻, HCOO⁻ and C₂O₄²⁻) bonded via an ionic bond with a cation (+) (for example, but not limited to, Al³⁺, Ca²⁺, Na⁺, K⁺, Cu²⁺, H⁺, Fe³⁺, Mg²⁺, NH⁴⁺ and H₃O⁺). In other embodiments, the salt comprises a cation (+) bonded via an ionic bond with an anion (−). In certain embodiments, the compounds of the present disclosure comprise a sodium salt or potassium salt of the compound.

In certain embodiments, the concentration of the compound differs between a freshly roasted peanut and a roasted peanut stored for a period of time. In certain embodiments, the concentration of the compound decreases over a period of storage of the peanut. In certain embodiments, the peanut is stored for at least about 1 day, at least about 2 days, at least about 3 days, at least about 4 days, at least about 5 days, at least about 6 days, at least about 1 week, at least about 2 weeks, at least about 3 weeks, at least about 4 weeks, at least about 1 month, at least about 2 months, at least about 3 months, at least about 4 months, at least about 6 months, at least about 6 months, at least about 1 year, at least about 2 years or more.

In certain embodiments, one or more compound can be present in a flavor composition at a concentration of from about 0.0001% to about 99.9% w/w, from 0.001% to about 99% w/w, from about 0.01% to about 95% w/w, from about 0.1% to about 90% w/w, from about 0.5% to about 85% w/w, from about 1% to about 80% w/w, from about 1.5% to about 75% w/w, from about 2% to about 70% w/w, from about 2.5% to about 65% w/w, from about 3% to about 60% w/w, from about 3.5% to about 55% w/w, from about 4% to about 50% w/w, from about 5% to about 45% w/w, from about 10% to about 40% w/w, from about 15% to about 35% w/w, or from about 20% to about 30% w/w or any intermediate value thereof.

In certain embodiments, one or more compound can be present in a flavor composition at a concentration of from about 10 pM to about 1 M, from about 1 nM to about 1 M, from about 1 μM to about 1 M, from about 1 mM to about 1 M, from about 10 mM to about 1 M, from about 100 mM to about 1 M, from about 250 mM to about 1 M, from about 500 mM to about 1 M, from about 750 mM to about 1 M, from about 0.001 μM to about 1 M, from about 0.001 μM to about 750 mM, from about 0.001 μM to about 500 mM, from about 0.001 μM to about 250 mM, from about 0.001 μM to about 100 mM, from about 0.001 μM to about 50 mM, from about 0.001 μM to about 25 mM, from about 0.001 μM to about 10 mM, from about 0.001 μM to about 1 mM, from about 0.001 AI to about 100 μM or from about 0.001 μM to about 10 μM or any intermediate value thereof.

In certain embodiments, one or more compound can be present in a flavor composition at a concentration of from about 0.01 ppm to about 1,000 ppm. For example, but not by way of limitation, the compound can be present in the amount from about 0.01 ppm to about 750 ppm, from about 0.01 ppm to about 500 ppm, from about 0.01 ppm to about 250 ppm, from about 0.01 ppm to about 150 ppm, from about 0.01 ppm to about 100 ppm, from about 0.01 ppm to about 75 ppm, from about 0.01 ppm to about 50 ppm, from about 0.01 ppm to about 25 ppm, from about 0.01 ppm to about 15 ppm, from about 0.01 ppm to about 10 ppm, from about 0.01 ppm to about 5 ppm, from about 0.01 ppm to about 4 ppm, from about 0.01 ppm to about 3 ppm, from about 0.01 ppm to about 2 ppm, from about 0.01 ppm to about 1 ppm, from about 0.01 ppm to about 1,000 ppm, from about 0.1 ppm to 1,000 ppm, from about 1 ppm to 1,000 ppm, from about 2 ppm to about 1,000 ppm, from about 3 ppm to about 1,000 ppm, from about 4 ppm to about 1,000 ppm, from about 5 ppm to about 1,000 ppm, from about 10 ppm to about 1,000 ppm, from about 15 ppm to about 1,000 ppm, from about 25 ppm to about 1,000 ppm, from about 50 ppm to about 1,000 ppm, from about 75 ppm to about 1,000 ppm, from about 100 ppm to about 1,000 ppm, from about 150 ppm to about 1,000 ppm, from about 250 ppm to about 1,000 ppm, from about 250 ppm to about 1,000 ppm, from about 500 ppm to about 1,000 ppm or from about 750 ppm to about 1,000 ppm or any intermediate value thereof.

### 3. Flavor Composition

The presently disclosed subject matter provides a flavor composition comprising one or more aroma compound disclosed herein, wherein the compound contributes to a peanut flavor. In certain embodiments, the compound can be any compound listed in Tables 1-18 of Examples 1 and 2, any derivative or analogy thereof, or any combination thereof.

In certain embodiments, the flavor composition comprises a first aroma compound selected from the group consisting of 2-acetyl-(1,4,5,6)-tetrahydropyridine, 2-acetyl-(3,4,5,6)-tetrahydropyridine, 2-acetyl-1-pyrroline, 2-propionyl-1-pyrroline, 2-acetylpyrazine and any combination thereof; a second aroma compound selected from the group consisting of 2,3-pentanedione, 2,3-butanedione and a combination thereof; and a third aroma compound selected from the group consisting of phenylacetaldehyde, phenylacetic acid and a combination thereof.

In certain embodiments, the concentration ratio of the first compound to the second compound to the third compound is a:b:c, wherein a ranges from about 0.1 to about 10, b ranges from about 10 to about 100, and c ranges from about 1 to about 100. In certain embodiments, a ranges from about 3 to about 8, b ranges from about 20 to about 60, and c ranges from about 10 to about 60. In certain embodiments, a is about 6, b is about 55, and c is about 58.

In certain embodiments, the flavor composition further comprises: a fourth aroma compound of 4-hydroxy-2,5-dimethyl-3(2H)-furanone; a fifth aroma compound selected from the group consisting of 2-methylbutanal, 3-methylbutanal and a combination thereof; a sixth aroma compound selected from the group consisting of 2-ethyl-3,5-dimethylpyrazine, 2,3-diethyl-5-methylpyrazine and a combination thereof; a seventh aroma compound of 2-methoxy-4-vinylphenol, and/or an eighth aroma compound selected from the group consisting of hydrogen sulfide, methanethiol, dimethyl trisulfide, methylpropanal and any combination thereof.

In certain embodiments, the concentration ratio of the first compound to the fourth compound to the fifth compound to the sixth compound to the seventh compound to the eighth compound is a:d:e:f:g:h, wherein a ranges from about 0.1 to about 10, d ranges from about 10 to about 40, e ranges from about 20 to about 90, f ranges from about 1 to about 10, g ranges from about 10 to about 40, and h ranges from about 50 to about 130.

The presently disclosed subject matter provides a flavor composition comprising an aroma compound selected from the group consisting of hydrogen sulfide, methanethiol, dimethyl trisulfide, methylpropanal and any combination thereof. In certain embodiments, the concentration ratio of hydrogen sulfide, methanethiol, dimethyl trisulfide, methylpropanal is w:x:y:z, wherein w ranges from about 10 to about 200, x ranges from about 1 to about 50, y ranges from about 1 to about 50, and z ranges from about 10 to about 200. In certain embodiments, w ranges from about 50 to about 100, x ranges from about 5 to about 20, y ranges from about 5 to about 20, and z ranges from about 30 to about 50.

In certain embodiments, the flavor composition further comprises one or more aroma compounds selected from the group consisting of 2,3-butanedione, methanethiol, 2-acetyl-1-pyrroline, 2-furfurylthiol, 2,3-pentanedione, 2-acetyl-(1,4,5,6)-tetrahydropyridine, 2-propionyl-1-pyrroline, 2-isopropyl-3-methoxypyrazine, dimethyl tri sulfide, methylpropanal, 2-ethyl-3,5-dimethylpyrazine, 2-acetyl-(3,4,5, 6)-tetrahydropyridine, phenylacetaldehyde, 2-methylbutanal, 3-methylbutanal, 2-isobutyl-3-methoxypyrazine, 3-(methylthio)-propanal, 4-hydroxy-2,5-dimethyl-3(2H)-furanone, hydrogen sulfide, acetic acid, 3-hydroxy-4,5-dimethyl-2(5H)-furanone, phenylacetic acid, 2-methoxy-4-vinylphenol, 2,3-diethyl-5-methylpyrazine, 1-octanol, 2-(sec-butyl)-3-methoxypyrazine, 2-methoxpyhenol, 2-acetylpyrazine, 2,3,5-trimethylpyrazine, 3-methylbutanoic acid, nonanal, octanal, 2-methylbutanoic acid, (Z)-2-nonenal, hexanal, hexanoic acid and pentanoic acid.

In certain embodiments, the flavor composition comprises one or more aroma compounds selected from the group consisting of acetic acid, hexanal, hydrogen sulfide, nonanal, methylpropanal, octanal, hexanoic acid, 2-methoxy-4-vinylphenol, decanoic acid, pentanoic acid, (E,Z)-2,4-nonadienal, 2,3,5-trimethylpyrazine, (E)-2-decenal, methanethiol, furfurylalcohol, (E)-2-undecenal, 2,5-dimethylpyrazine, 1-octanol, 2,3-dimethylpyrazine, 2-methylbutanoic acid, 2-methylbutanal, furfural, 2,3-diethyl-5-methylpyrazine, 4-hydroxy-2,5-dimethyl-3(2H)-furanone, 2-phenylethanol, phenylacetic acid, 3-methylbutanal, 3-methylbutanoic acid, 2,3-butanedione, 2-acetylpyrazine, 4-hydroxy-3-methoxy-benzaldehyde, (E)-2-nonenal, phenylacetaldehyde, 3-ethyl-2,5-dimethylpyrazine, 2,3-pentanedione, (Z)-2-decenal, dimethyl trisulfide, 2-ethyl-3,5-dimethylpyrazine, 2-methoxpyhenol, 2-acetyl-(3,4,5,6)-tetrahydropyridine, δ-nonalactone, 3-(methylthio)-propanal, 2-propionyl-1-pyrroline, 1-octen-3-one, 2-acetylpyridine, 3-hydroxy-4,5-dimethyl-2(5H)-furanone, 2-furfurylthiol, (Z)-2-nonenal, 2-(sec-butyl)-3-methoxypyrazine, 2-isopropyl-3-methoxypyrazine, 2-isobutyl-3-methoxypyrazine, 2-acetyl-(1,4,5,6)-tetrahydro-pyridine and 2-acetyl-1-pyrroline.

In certain embodiments, the composition further comprises an edible carrier. In certain embodiments, the edible carrier is a water/oil mixture.

A broad range of concentrations of the flavor compositions can be employed to provide such palatability modification. In certain embodiments of the present application, the flavor composition is admixed with a food product wherein the flavor composition is present in an amount of from about 0.001 to about 500 ppb, from about 0.005 to about 250 ppb, from about 0.01 to about 200 ppb, from about 0.05 to about 150 ppb, from about 0.1 to about 100 ppb, or from about 0.5 to about 50 ppb or any intermediate value thereof.

In certain embodiments, the flavor composition is admixed with a food product at a concentration of from about 0.01 to about 10000 ppb, or any intermediate value thereof. In certain embodiments, the flavor composition is admixed with a food product at a concentration of from about 0.1 to about 1000 ppb, or any intermediate value thereof. In certain embodiments, the flavor composition is admixed with a food product at a concentration of from about 1 to about 100 ppb, or any intermediate value thereof. In certain embodiments, the flavor composition is admixed with a food product at a concentration of from about 10 to about 50 ppb, or any intermediate value thereof. In certain embodiments, the flavor composition is admixed with a food product at a concentration of from about 0.1 to about 10 ppb, or any intermediate value thereof.

In certain embodiments, the flavor composition is admixed with a food product at a concentration of from about 0.1 to about 10000 ppb, from about 1 to about 5000 ppb, from about 10 to about 2000 ppb, from about 20 to about 1500 ppb, from about 30 to about 1000 ppb, from about 40 to about 500 ppb, from about 50 to about 250 ppb, from about 60 to about 200 ppb, from about 70 to about 150 ppb, or from about 80 to about 100 ppb or any intermediate value thereof.

In certain embodiments, the flavor composition is admixed with a food product at a concentration of from about 0.1 to about 1 ppb, from about 1 to about 5 ppb, from about 5 to about 10 ppb, from about 10 to about 15 ppb, from about 15 to about 20 ppb, from about 20 to about 25 ppb, from about 25 to about 30 ppb, from about 30 to about 35 ppb, from about 35 to about 40 ppb, from about 40 to about 45 ppb, from about 45 to about 50 ppb, from about 50 to about 55 ppb, from about 55 to about 60 ppb, from about 60 to about 65 ppb, from about 65 to about 70 ppb, from about 70 to about 75 ppb, from about 75 to about 80 ppb, from about 80 to about 85 ppb, from about 85 to about 90 ppb from about 90 to about 95 ppb, from about 95 to about 100 ppb, from about 100 to about 150 ppb, from about 150 to about 200 ppb, from about 200 to about 250 ppb, from about 250 to about 300 ppb, from about 300 to about 350 ppb, from about 350 to about 400 ppb, from about 400 to about 450 ppb, from about 450 to about 500 ppb, from about 500 to about 550 ppb, from about 550 to about 600 ppb, from about 600 to about 650 ppb, from about 650 to about 700 ppb, from about 700 to about 750 ppb, from about 750 to about 800 ppb, from about 800 to about 850 ppb, from about 850 to about 900 ppb, from about 900 to about 950 ppb, or from about 950 to about 1000 ppb or any intermediate value thereof.

In certain embodiments, the flavor composition is admixed with a food product at a concentration of about 0.1 ppb, about 0.5 ppb, about 1 ppb, about 10 ppb, about 50 ppb, about 100 ppb, about 200 ppb, about 300 ppb, about 500 ppb, about 1000 ppb or about 1500 ppb.

In certain embodiments, the range of concentrations can include from about 1 ppb to about 100 ppb, less than about 100 ppb, at least about 30 ppb, or from about 30 ppb to about 1% w/w by weight of the food product.

In certain embodiments of the present application, the flavor composition is admixed with a food product wherein the flavor composition is present in an amount of from about 0.001 ppm to about 100 ppm, or narrower alternative ranges from about 0.1 ppm to about 10 ppm, from about 0.01 ppm to about 30 ppm, from about 0.05 ppm to about 15 ppm, from about 0.1 ppm to about 5 ppm, or from about 0.1 ppm to about 3 ppm or any intermediate value thereof.

In certain embodiments, the flavor composition is admixed with a food product at a concentration of from about 0.1 to about 100 ppm, or any intermediate value thereof. In certain embodiments, the flavor composition is admixed with a food product at a concentration of from about 0.1 to about 50 ppm, or any intermediate value thereof. In certain embodiments, the flavor composition is admixed with a food product at a concentration of from about 0.1 to about 10 ppm, or any intermediate value thereof.

In certain embodiments, the flavor composition is admixed with a food product at a concentration of from about 0.1 to about 100 ppm, from about 1 to about 90 ppm, from about 10 to about 80 ppm, from about 20 to about 70 ppm, from about 30 to about 60 ppm, or from about 40 to about 50 ppm or any intermediate value thereof.

In certain embodiments, the flavor composition is admixed with a food product at a concentration of from about 0.1 to about 1 ppm, from about 1 to about 5 ppm, from about 5 to about 10 ppm, from about 10 to about 15 ppm, from about 15 to about 20 ppm, from about 20 to about 25 ppm, from about 25 to about 30 ppm, from about 30 to about 35 ppm, from about 35 to about 40 ppm, from about 40 to about 45 ppm, from about 45 to about 50 ppm, from about 50 to about 55 ppm, from about 55 to about 60 ppm, from about 60 to about 65 ppm, from about 65 to about 70 ppm, from about 70 to about 75 ppm, from about 75 to about 80 ppm, from about 80 to about 85 ppm, from about 85 to about 90 ppm from about 90 to about 95 ppm, or from about 95 to about 100 ppm or any intermediate value thereof.

In certain embodiments, the flavor composition is admixed with a food product at a concentration of from about 0.0001% to about 99.9% weight/weight (w/w), or any intermediate value thereof. In certain embodiments, the flavor composition is admixed with a food product at a concentration of from about 0.0001% to about 1.0% w/w or any intermediate value thereof.

In certain embodiments, the flavor composition is admixed with a food product at a concentration of from about 0.0001% to about 0.5% w/w, or any intermediate value thereof.

In certain embodiments, the flavor composition is admixed with a food product at a concentration of from about 0.0001% to about 99.9% w/w, from 0.001% to about 99% w/w, from about 0.01% to about 95% w/w, from about 0.1% to about 90% w/w, from about 0.5% to about 85% w/w, from about 1% to about 80% w/w, from about 1.5% to about 75% w/w, from about 2% to about 70% w/w, from about 2.5% to about 65% w/w, from about 3% to about 60% w/w, from about 3.5% to about 55% w/w, from about 4% to about 50% w/w, from about 5% to about 45% w/w, from about 10% to about 40% w/w, from about 15% to about 35% w/w, or from about 20% to about 30% w/w, or any intermediate value thereof.

In certain embodiments of the present application, the flavor composition is admixed with a food product wherein the flavor composition is present in an amount of from about 0.0000001% to about 99.999% weight/weight (w/w), from about 0.00005% to about 75% w/w, from about 0.0001% to about 50% w/w, from about 0.0005% to about 25% w/w, from about 0.001% to about 10% w/w, or from about 0.005% to about 5% w/w of the food product or any intermediate value thereof.

In certain embodiments, the flavor composition is admixed with a food product in an effective amount, such that a subject would be able to tell the food product apart from a food product prepared without the flavor composition, wherein the subject is a human being or animal in general, or in the case of formulation testing, as determined by a taste panel of at least one, two, three, four, five or more human taste testers, via procedures known in the art.

### 4. Delivery Systems

In certain embodiments, the flavor compositions of the present application can be incorporated into a delivery system for use in food products. Delivery systems can be a non-aqueous liquid, solid, or emulsion. Delivery systems are generally adapted to suit the needs of the flavor composition and/or the food product into which the flavor composition will be incorporated.

The flavoring compositions can be employed in non-aqueous liquid form, dried form, solid form and/or as an emulsion. When used in dried form, suitable drying means such as spray drying can be used. Alternatively, a flavoring composition can be encapsulated or absorbed onto water insoluble materials. The actual techniques for preparing such dried forms are well-known in the art and can be applied to the presently disclosed subject matter.

The flavor compositions of the presently disclosed subject matter can be used in many distinct physical forms well known in the art to provide an initial burst of taste, flavor and/or texture; and/or a prolonged sensation of taste, flavor and/or texture. Without being limited thereto, such physical forms include free forms, such as spray dried, powdered, and beaded forms, and encapsulated forms, and mixtures thereof.

In certain embodiments, the compounds of a flavor composition can be generated during the processing of a food product, e.g., sterilization, retorting and/or extrusion, from precursor compounds present in the food product.

In certain embodiments, as noted above, encapsulation techniques can be used to modify the flavor systems. In certain embodiments, flavor compounds, flavor components or the entire flavor composition can be fully or partially encapsulated. Encapsulating materials and/or techniques can be selected to determine the type of modification of the flavor system.

In certain embodiments, the encapsulating materials and/or techniques are selected to improve the stability of the flavor compounds, flavor components or flavor compositions; while in other embodiments the encapsulating materials and/or techniques are selected to modify the release profile of the flavor compositions.

Suitable encapsulating materials can include, but are not limited to, hydrocolloids such as alginates, pectins, agars, guar gums, celluloses, and the like, proteins, polyvinyl acetate, polyethylene, crosslinked polyvinyl pyrrolidone, polymethylmethacrylate, polylactidacid, polyhydroxyalkanoates, ethylcellulose, polyvinyl acetatephthalate, polyethylene glycol esters, methacrylicacid-co-methylmethacrylate, ethylene-vinylacetate (EVA) copolymer, and the like, and combinations thereof. Suitable encapsulating techniques can include, but are not limited to, spray coating, spray drying, spray chilling, absorption, adsorption, inclusion complexing (e.g., creating a flavor/cyclodextrin complex), coacervation, fluidized bed coating or other process can be used to encapsulate an ingredient with an encapsulating material.

Encapsulated delivery systems for flavoring agents or sweetening agents can contain a hydrophobic matrix of fat or wax surrounding a sweetening agent or flavoring agent core. The fats can be selected from any number of conventional materials such as fatty acids, glycerides or poly glycerol esters, sorbitol esters, and mixtures thereof. Examples of fatty acids include but are not limited to hydrogenated and partially hydrogenated vegetable oils such as palm oil, palm kernel oil, peanut oil, rapeseed oil, rice bran oil, soybean oil, cottonseed oil, sunflower oil, safflower oil and combinations thereof. Examples of glycerides include, but are not limited to, monoglycerides, diglycerides and triglycerides.

Waxes can be chosen from the group consisting of natural and synthetic waxes and mixtures thereof. Non-limiting examples include paraffin wax, petrolatum, carbowax, microcrystalline wax, beeswax, carnauba wax, candelilla wax, lanolin, bayberry wax, sugarcane wax, spermaceti wax, rice bran wax, and mixtures thereof.

The fats and waxes can be used individually or in combination in amounts varying from about 10 to about 70%, and alternatively in amounts from about 30 to about 60%, by weight of the encapsulated system. When used in combination, the fat and wax can be present in a ratio from about 70:10 to 85:15, respectively.

Typical encapsulated flavor compositions, flavoring agent or sweetening agent delivery systems are disclosed in U.S. Pat. Nos. 4,597,970 and 4,722,845, the disclosures of which are incorporated herein by reference in their entireties.

Liquid delivery systems can include, but are not limited to, systems with a dispersion of the flavor compositions of the present application, such as in carbohydrate syrups and/or emulsions. Liquid delivery systems can also include extracts where the compound and/or the flavor compositions are solubilized in a solvent. Solid delivery systems can be created by spray drying, spray coating, spray chilling, fluidized bed drying, absorption, adsorption, coacervation, complexation, or any other standard technique. In some embodiments, the delivery system can be selected to be compatible with or to function in the edible composition. In certain embodiments, the delivery system will include an oleaginous material such as a fat or oil. In certain embodiments, the delivery system will include a confectionery fat such as cocoa butter, a cocoa butter replacer, a cocoa butter substitute, or a cocoa butter equivalent. When used in dried form, suitable drying means such as spray drying can be used.

Alternatively, a flavoring composition can be adsorbed or absorbed onto substrates, such as water insoluble materials, and can be encapsulated. The actual techniques for preparing such dried forms are well known in the art.

### 5. End Product Systems

The flavoring compositions of the present disclosed subject matter can be used in a wide variety of ingestible vehicles. Non-limiting examples of suitable ingestible vehicles include chewing gum compositions, hard and soft confections, dairy products, beverage products including juice products and soft drinks, pharmaceuticals, bakery goods, frozen foods, food products and food categories described herein. The combination of the flavoring composition of the presently disclosed subject matter together with an ingestible vehicle and optional ingredients, when desired, provides a flavoring agent that possesses unexpected taste, flavor and/or texture value and imparts, for example, a roasted peanut sensory experience.

In the method for flavoring an ingestible composition of the presently disclosed subject matter, the ingestible composition is prepared by admixing the flavoring agent in an ingestible vehicle, together with any optional ingredients, to form a uniform mixture. The final compositions are readily prepared using standard methods and apparatus generally known by those skilled in the corresponding arts, such as confectionary arts. The apparatus useful in accordance with the presently disclosed subject matter comprises mixing apparatus well known in the art, and therefore the selection of the specific apparatus will be apparent to the artisan.

In certain embodiments, the present application relates to the modified edible food products produced by the methods disclosed herein. In certain embodiments, the food products can be produced by processes for producing comestible products well known to those of ordinary skill in the art.

The flavor composition and its various subgenuses can be combined with or applied to a comestible or medicinal products or precursor thereof in any of innumerable ways known to cooks the world over, or producers of comestible or medicinal products. For example, the flavor compositions can be dissolved in or dispersed in one of many known comestibly acceptable liquids, solids, or other carriers, such as water at neutral, acidic, or basic pH, fruit or vegetable juices, vinegar, marinades, beer, wine, natural water/fat emulsions such as milk or condensed milk, whey or whey products, edible oils and shortenings, fatty acids, certain low molecular weight oligomers of propylene glycol, glyceryl esters of fatty acids, and dispersions or emulsions of such hydrophobic substances in aqueous media, salts such as sodium chloride, vegetable flours, solvents such as ethanol, solid edible diluents such as vegetable powders or flours, and the like, and then combined with precursors of the comestible or medicinal products, or applied directly to the comestible or medicinal products.

In certain embodiments, the flavor compositions of the present application can be admixed with foods, beverages and other comestible compositions wherein savory compounds, especially NaCl, MSG, inosine monophosphate (IMP), or guanosine monophosphate (GMP) are conventionally utilized. These compositions include compositions for human and animal consumption, for example, food or drinks (liquids) for consumption by agricultural animals, pets and zoo animals. Those of ordinary skill in the art of preparing and selling comestible compositions (i.e., edible foods or beverages, or precursors or flavor modifiers thereof) are well aware of a large variety of classes, subclasses and species of the comestible compositions, and utilize well-known and recognized terms of art to refer to those comestible compositions while endeavoring to prepare and sell various of those comestible compositions. Such a list of terms of art is enumerated below, and it is specifically contemplated hereby that the flavor compositions of the present application can be used to modify or enhance a peanut flavor of the following list edible compositions, either singly or in all reasonable combinations or mixtures thereof.

In certain embodiments, the food products to which the flavor compositions of the present application are admixed with comprise, by way of example, the wet soup category, the dehydrated and culinary food category, the beverage category, the frozen food category, the snack food category, and seasonings or seasoning blends, described herein.

In other embodiments, the flavor compositions of the present application are admixed with one or more confectioneries, chocolate confectionery, tablets, countlines, bagged selfmies/softlines, boxed assortments, standard boxed assortments, twist wrapped miniatures, seasonal chocolate, chocolate with toys, allsorts, other chocolate confectionery, mints, standard mints, power mints, boiled sweets, pastilles, gums, jellies and chews, toffees, caramels and nougat, medicated confectionery, lollipops, liquorice, other sugar confectionery, gum, chewing gum, sugarised gum, sugar-free gum, functional gum, bubble gum, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes, breakfast cereals, rte cereals, family breakfast cereals, flakes, muesli, other rte cereals, children's breakfast cereals, hot cereals, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, cream, cheese, processed cheese, spreadable processed cheese, unspreadable processed cheese, unprocessed cheese, spreadable unprocessed cheese, hard cheese, packaged hard cheese, unpackaged hard cheese, yoghurt, plain/natural yoghurt, flavored yoghurt, fruited yoghurt, probiotic yoghurt, drinking yoghurt, regular drinking yoghurt, probiotic drinking yoghurt, chilled and shelf-stable desserts, dairy-based desserts, soy-based desserts, chilled snacks, fromage frais and quark, plain fromage frais and quark, flavored fromage frais and quark, savory fromage frais and quark, sweet and savory snacks, fruit snacks, chips/crisps, extruded snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, uht soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned meat and meat products, canned fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, chilled noodles, oils and fats, olive oil, vegetable and Seed oil, cooking fats, butter, margarine, spreadable oils and fats, functional spreadable oils and fats, sauces, dressings and condiments, tomato pastes and purees, bouillon/stock cubes, stock cubes, gravy granules, liquid stocks and fonds, herbs and spices, fermented sauces, soy based sauces, pasta sauces, wet sauces, dry sauces/powder mixes, ketchup, mayonnaise, regular mayonnaise, mustard, salad dressings, regular salad dressings, low fat salad dressings, vinaigrettes, dips, pickled products, other sauces, dressings and condiments, baby food, milk formula, standard milk formula, follow-on milk formula, toddler milk formula, hypoallergenic milk formula, prepared baby food, dried baby food, other baby food, spreads, jams and preserves, honey, chocolate spreads, nut-based spreads, and yeast-based spreads.

The flavor systems can be used in sugarless gum formulations and can also be used in a sugar chewing gum. The flavor systems can be used in either regular chewing gum or bubble gum. Various specifics of chewing gum compositions are disclosed in U.S. Pat. No. 6,899,911, the disclosure of which is incorporated herein by reference in its entirety.

Another important aspect of the presently disclosed subject matter includes a confectionery composition incorporating the inventive flavoring agent and a method for preparing the confectionery compositions. The preparation of confectionery formulations is well-known in the art. Confectionery items have been classified as either “hard” confectionery or “soft” confectionery. The flavoring agents of the presently disclosed subject matter can be incorporated into the confections by admixing the compositions of the presently disclosed subject matter into the conventional hard and soft confections.

The presently disclosed subject matter is also used with and/or in chocolate products, chocolate-flavored confections, and chocolate flavored compositions. Chocolates also include those containing crumb solids or solids fully or partially made by a crumb process. Various chocolates are disclosed, for example, in U.S. Pat. Nos. 7,968,140 and 8,263,168, the disclosures of which are incorporated herein by reference in their entireties. A general discussion of the composition and preparation of chocolate confections can be found in B. W. Minifie, Chocolate, Cocoa and Confectionery: Science and Technology, 2nd edition, AVI Publishing Co., Inc., Westport, Conn. (1982), which disclosure is incorporated herein by reference.

In certain embodiments, the flavor compositions of the present application are incorporated into savory goods to enhance or modify a peanut flavor. In certain embodiments, a savory good is a food product that has savory flavors including, for example, but not limited to, spicy flavor, pepper flavor, dairy flavor, vegetable flavor, tomato flavor, dill flavor, meat flavor, poultry flavor, chicken flavor and reaction flavors that are added or generated during heating of a food product.

The flavoring compositions can also be in the form of a pharmaceutical. One nonlimiting example of a pharmaceutical form is a suspension. Pharmaceutical suspensions can be prepared by conventional compounding methods. Suspensions can contain adjunct materials employed in formulating the suspensions of the art. The suspensions of the presently disclosed subject matter can comprise preservatives, buffers, suspending agents, antifoaming agents, sweetening agents, flavoring agents, coloring or decoloring agents, solubilizers, and combinations thereof. Flavoring agents such as those flavors well known to the skilled artisan, such as natural and artificial flavors and mints, such as peppermint, menthol, citrus flavors such as orange and lemon, artificial vanilla, cinnamon, various fruit flavors, both individual and mixed and the like can be utilized in amounts from about 0.01% to about 5%, and more preferably 0.01% to about 0.5% by weight of the suspension.

### 6. Methods of Measuring Flavor Attributes

In certain embodiments of the present application, the flavor attributes of a food product can be modified by admixing a flavor composition with the food product as described herein. In certain embodiments, the attribute(s) can be enhanced or reduced by increasing or decreasing the concentration of the flavor composition admixed with the food product. In certain embodiments, the flavor attributes of the modified food product can be evaluated as described herein, and the concentration of flavor composition admixed with the food product can be increased or decreased based on the results of the evaluation.

Flavor attributes can be reliably and reproducibly measured using sensory analysis methods known as descriptive analysis techniques. The Spectrum™ method of descriptive analysis is described in Morten Meilgaard, D. Sc. et al., Sensory Evaluation Techniques (3d ed. 1999). The Spectrum™ method is a custom design approach meaning that the highly trained panelists who generate the data also develop the terminology to measure the attributes of interest. Further, the method uses intensity scales created to capture the intensity differences being investigated. These intensity scales are anchored to a set of well-chosen references. Using these references helps make the data universally understandable and usable over time. This ability to reproduce the results at another time and with another panel makes the data potentially more valuable than analytical techniques which offer similar reproducibility but lack the ability to fully capture the integrated sensory experiences as perceived by humans.

### EXAMPLES

The presently disclosed subject matter can be better understood by reference to the following Examples, which are provided as exemplary of the invention, and not by way of limitation.

### Example 1—Identification of Aroma Compounds in High Oleic Acid Peanuts and Low Oleic Acid Peanuts

### Materials and Methods

The peanut samples are vacuumed and stored at 6° C. prior to roasting. High oleic acid peanuts are raw and blanched samples from Argentina.

Unroasted peanuts are roasted with the Hottop Home Coffee Roaster KN-8828B-2-K. The roasting occurs at different temperatures and color measurements are taken for the freshly roasted peanuts. At a temperature of 75° C., 250 g peanuts are introduced into the roaster. When the roaster reaches after 15 minutes a temperature of 163° C. the peanuts are ejected onto the cooling tray, where the peanuts are cooled down for 5 minutes.

To isolate the volatile compounds from the peanut samples, a cold-extraction with diethyl ether followed by a high vacuum distillation of the solvent extract is used. A solvent assisted flavor evaporation (SAFE-distillation) is used to separate the volatiles from the non-volatiles in the solvent extract. The distillate is separated into neutral-basic and acidic fractions. Each fraction is subject to gas chromatography analysis with olfactometric detection (GC-O) and gas chromatography-mass spectrometry (GC-MS).

A combination of instrumental analyses with sensory valuation is conducted to differentiate between odorless volatiles and odor-active aroma compounds contained in aroma extracts. Aroma Extract Dilution Analyses (AEDA) are conducted to evaluate the important odor compounds, which contribute to the overall aroma of the peanut sample. In a comparative AEDA, different peanut samples are prepared under exactly the same conditions.

Highly volatile aroma compounds are overlapped by the solvent peak of the on-column injection, consequently they are imperceptible during AEDA. Therefore, static headspace aroma dilution analyses (SHA) are conducted for the detection of highly volatile compounds. Roasted peanut meal (7 g) is treated with the same amount of water (1:1, v/v), placed into a septum-sealed vial and equilibrated for 30 min at 40° C. The headspace volumes of the sample are stepwise reduced (10 mL, 5 mL, 2.5 mL, 1.25 mL, 0.6 mL, 0.3 mL, 0.15 mL and 0.1 mL) and analyzed by static headspace gas chromatography analysis with olfactometric detection (SH-GC-O). Each odor-active compound is assigned an FD-factor, calculated as ratio of the highest analyzed headspace volume (10 mL) and the lowest headspace volume in which the compound is detected at the sniffing port.

The Stable Isotope Dilution Assays (SIDA) are used to quantitate the aroma compounds. The concentrations of the isotopically labeled standards are analyzed first for SIDA. Methyl octanoate is used as internal standard. The analytes' concentrations are calculated by the different molecular weight of internal standard and the analytes using a GC-MS system.

### Results

53 aroma-active compounds are quantified using stable isotope dilution assays (SIDA) as shown in Table 1.

TABLE 1
Concentrations of the important odorants in
freshly (f) roasted high oleic acid peanuts

| | concentration [μg/kg] | | | |
|---|---|---|---|---|
| odor compound | average^{a} | range^{b} | n^{c} | RSD [%]^{d} |
| acetic acid | 27522 | 26521-28894 | 3 | 5 |
| hydrogen sulfide | 7807 | 7672-7974 | 3 | 2 |
| phenylacetaldehyde | 5260 | 5193-5363 | 3 | 2 |
| 2-methylbutanal | 4883 | 4548-5231 | 3 | 7 |
| methylpropanal | 3960 | 3546-4448 | 3 | 12 |
| 4-hydroxy-2,5-dimethyl- | 3401 | 3014-3935 | 3 | 14 |
| 3(2H)-furanone | | | | |
| 2,3-pentanedione | 2770 | 2724-2849 | 3 | 3 |
| 2,3-butanedione | 2759 | 2577-2975 | 3 | 7 |
| 2-methoxy-4-vinylphenol | 2315 | 2166-2388 | 3 | 6 |
| 3-methylbutanal | 2078 | 1834-2401 | 3 | 14 |
| nonanal | 1612 | 1549-1674 | 2 | 6 |
| decanoic acid | 1284 | 1190-1377 | 2 | 10 |
| 2,3,5-trimethylpyrazine | 1191 | 1167-1212 | 3 | 2 |
| methanethiol | 901 | 820-982 | 2 | 13 |
| 2,5-dimethylpyrazine | 850 | 743-979 | 3 | 14 |
| (E,Z)-2,4-nonadienal | 835 | 734-902 | 3 | 11 |
| phenylacetic acid | 639 | 585-678 | 3 | 8 |
| furfurylalcohol | 408 | 383-452 | 3 | 9 |
| octanal | 329 | 321-336 | 3 | 2 |
| 2-ethyl-3,5-dimethylpyrazine | 299 | 290-305 | 3 | 3 |
| 1-octanol | 266 | 249-283 | 2 | 9 |
| furfural | 236 | 233-240 | 3 | 2 |
| hexanoic acid | 231 | 224-242 | 3 | 4 |
| 2,3-dimethylpyrazine | 219 | 207-238 | 3 | 8 |
| (E)-2-undecenal | 204 | 199-210 | 3 | 3 |
| 2-acetyl-(3,4,5,6)- | 187 | 176-197 | 3 | 6 |
| tetrahydropyridine | | | | |
| 2-acetyl-(1,4,5,6)- | 176 | 166-192 | 3 | 8 |
| tetrahydropyridine | | | | |
| (E)-2-decenal | 164 | 158-172 | 3 | 4 |
| 2-acetylpyrazine | 148 | 146-150 | 3 | 1 |
| 2,3-diethyl-5-methylpyrazine | 121 | 120-123 | 3 | 1 |
| 2-phenylethanol | 116 | 108-125 | 3 | 7 |
| 2-methylbutanoic acid | 112 | 106-116 | 3 | 5 |
| 4-hydroxy-3-methoxy- | 104 | 95.1-119 | 3 | 13 |
| benzaldehyde | | | | |
| hexanal | 83.6 | 81.3-84.9 | 3 | 2 |
| 3-(methylthio)-propanal | 67.5 | 66.3-68.9 | 3 | 2 |
| 3-methylbutanoic acid | 56.5 | 54.7-58.4 | 3 | 3 |
| 3-ethyl-2,5-dimethylpyrazine | 54.8 | 48.3-66.0 | 3 | 18 |
| 2-acetyl-1-pyrroline | 54.5 | 53.8-54.9 | 3 | 1 |
| pentanoic acid | 44.5 | 42.9-47.3 | 3 | 6 |
| 2-propionyl-1-pyrroline | 36.1 | 30.6-39.0 | 3 | 13 |
| 2-methoxpyhenol | 21.2 | 19.9-23.4 | 3 | 9 |
| (Z)-2-decenal | 21.0 | 20.4-21.8 | 3 | 3 |
| 2-acetylpyridine | 15.8 | 15.3-16.6 | 3 | 5 |
| 3-hydroxy-4,5-dimethyl- | 15.5 | 14.8-16.3 | 3 | 5 |
| 2(5H)-furanone | | | | |
| 2-furfurylthiol | 14.6 | 13.3-16.6 | 3 | 12 |
| (E)-2-nonenal | 13.3 | 13.1-13.5 | 3 | 1 |
| dimethyl trisulfide | 9.56 | 9.16-9.93 | 3 | 4 |
| δ-nonalactone | 6.80 | 6.67-6.92 | 2 | 3 |
| 2-(sec-butyl)-3- | 6.38 | 6.32-6.47 | 3 | 1 |
| methoxypyrazine | | | | |
| 2-isobutyl-3- | 5.32 | 5.27-5.37 | 3 | 1 |
| methoxypyrazine | | | | |
| 2-isopropyl-3- | 5.01 | 5.00-5.02 | 3 | 0 |
| methoxypyrazine | | | | |
| (Z)-2-nonenal | 4.24 | 4.12-4.35 | 3 | 3 |
| 1-octen-3-one | 2.14 | 2.01-2.34 | 3 | 8 |

^{a}Average values are calculated from n determinations.
^{b}The range shows the smallest and the highest concentration measured within n determinations.
^{c}Number of determinations.
^{d}Relative standard deviation (RSD).

Furthermore, static headspace gas chromatography analysis with olfactometric detection (SH-GC-O) is used to complete an AEDA in order to cover highly volatile aroma compounds. Sequenced series of decreasing gas volumes in the headspace of the roasted peanuts are analyzed. Four compounds for freshly roasted peanuts are perceived and identified by comparing their mass spectra recorded in the EI-mode and the odor quality with the corresponding reference compounds. These compounds are hydrogen sulfide, methanethiol, dimethyl sulfide and methylpropanal for freshly roasted peanuts (Table 2). Methanethiol with its sulfury smelling and methylpropanal with its malty smelling are analyzed as the most odor-active aroma compounds, since these odorants are perceivable in a volume of 0.15 mL (FD 64). The highly volatile compounds hydrogen sulfide (sulfury, FD 2) and dimethyl sulfide (cabbage-like; FD 1) additionally can be identified.

TABLE 2
Key odorants of freshly (f) roasted high oleic
acid peanuts (HOAP) by means of headspace-GC-O

| | | odor | | | |
|---|---|---|---|---|---|
| No. | odorant^{a} | quality^{b} | RI_{DB-5}_{^{c}} | volume^{d} (mL) | FD^{e} (f) |
| 1 | hydrogen sulfide ^{f} | sulfury | 446 | 5.00 | 2 |
| 2 | methanethiol ^{f} | sulfury | 510 | 0.15 | 64 |
| 3 | dimethyl sulfide | cabbage- | 594 | 10.0 | 1 |
| | | like | | | |
| 4 | methylpropanal | malty | 631 | 0.15 | 64 |

^{a}The compound is identified by comparing its mass spectra (MS-EI), retention indices on capillary DB-5 as well as the odor quality during sniffing with data of reference compounds.
^{b}Odor quality taken out of the database from the Leibniz-LSB@TUM.
^{c}Retention index on DB-5-column.
^{d}Relative Flavor dilution factor is calculated as the ratio of the highest analyzed volume and the lowest volume in which the odorant is still perceivable.
^{e}Flavor dilution factor determined by SH-AEDA.
^{f} The compound was identified by the odor quality during sniffing.

Odor activity values (OAV) are calculated to estimate the importance of the single aroma compound on the overall odor of the peanut sample. Since the freshly roasted peanuts contained 48% of fat, the odor thresholds were determined in sunflower oil. 53 odor activity values are calculated in the freshly roasted peanuts (Table 3). A total number of 34 odorants show OAVs ≥1. These aroma compounds contribute to the overall flavor of the peanuts.

TABLE 3
Odor Activity Values of important odorants
in freshly roasted high oleic acid peanuts

| odorant | OAV^{a} | OOT (μg/kg)^{b} |
|---|---|---|
| 2,3-butanedione | 3066 | 0.9 |
| methanethiol | 2502 | 0.36 |
| 2-acetyl-1-pyrroline | 1028 | 0.053 |
| 2-furfurylthiol | 767 | 0.019 |
| 2,3-pentanedione | 616 | 4.5 |
| 2-acetyl-(1,4,5,6)-tetrahydropyridine | 549 | 0.32 |
| 2-propionyl-1-pyrroline | 515 | 0.07 |
| 2-isopropyl-3-methoxypyrazine | 501 | 0.01 |
| dimethyl tri sulfide | 319 | 0.03 |
| methylpropanal | 264 | 15 |
| 2-ethyl-3,5-dimethylpyrazine | 176 | 1.7 |
| 2-acetyl-(3,4,5,6)-tetrahydropyridine | 156 | 1.2 |
| phenylacetaldehyde | 155 | 37 |
| 2-methylbutanal | 144 | 34 |
| 3-methylbutanal | 139 | 15 |
| 2-isobutyl-3-methoxypyrazine | 133 | 0.04 |
| 3-(methylthio)-propanal | 130 | 0.52 |
| 4-hydroxy-2,5-dimethyl-3(2H)-furanone | 126 | 27 |
| hydrogen sulfide | 78 | 100 |
| acetic acid | 77 | 350 |
| 3-hydroxy-4,5-dimethyl-2(5H)-furanone | 68 | 0.23 |
| phenylacetic acid | 25 | 26 |
| 2-methoxy-4-vinylphenol | 24 | 98 |
| 2,3-diethyl-5-methylpyrazine | 17 | 7.2 |
| 1-octanol | 15 | 18 |
| 2-(sec-butyl)-3-methoxypyrazine | 14 | 0.46 |
| 2-methoxpyhenol | 12 | 1.8 |
| 2-acetylpyrazine | 9 | 16 |
| 2,3,5-trimethylpyrazine | 7 | 180 |
| 3-methylbutanoic acid | 5 | 11 |
| nonanal | 3 | 610 |
| octanal | 2 | 140 |
| 2-methylbutanoic acid | 1 | 110 |
| (Z)-2-nonenal | 1 | 3.6 |
| 2-acetylpyridine | <1 | 48 |
| decanoic acid | <1 | 230000 |
| (E)-2-decenal | <1 | 2200 |
| (Z)-2-decenal | <1 | 50 |
| 2,3-dimethylpyrazine | <1 | 4500 |
| 2,5-dimethylpyrazine | <1 | 1700 |
| 3-ethyl-2,5-dimethylpyrazine | <1 | 76 |
| furfural | <1 | 28000 |
| furfurylalcohol | <1 | 700 |
| hexanal | <1 | 300 |
| hexanoic acid | <1 | 460 |
| 4-hydroxy-3-methoxy-benzaldehyde | <1 | 140 |
| (E,Z)-2,4-nonadienal | <1 | 2500 |
| δ-nonalactone | <1 | 550 |
| (E)-2-nonenal | <1 | 140 |
| 1-octen-3-one | <1 | 61 |
| pentanoic acid | <1 | 400 |
| 2-phenylethanol | <1 | 490 |
| (E)-2-undecenal | <1 | 7700 |

^{a}Odor Activity Value.
^{b}Odor Threshold in sunflower oil.

To simulate the aroma of freshly roasted high oleic acid peanuts on the basis of the quantitative data, an aroma model is prepared. For the aroma model 34 quantified aroma compounds with an odor activity value ≥1 are dissolved in sunflower oil in the concentrations determined in the sample. The recombinate is directly compared with freshly roasted peanuts, giving the odor impressions from which the panel evaluates according to an intensity of 0 to 3.

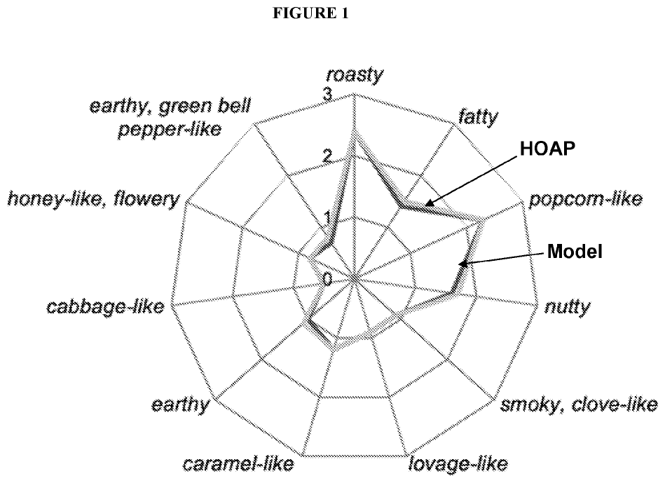

FIG. 1 shows that the aroma model exhibited a close similarity in the earthy, green bell pepper-like, the earthy, nutty and fatty notes (deviation 0.1). For the other aroma impressions, the aroma model and the freshly roasted high oleic acid peanuts are judged as identic in their aroma profiles. The panelists judge the peanuts either to their similarity to the aroma recombination (0=no similarity, 1=low similarity, 2=food detected, 3=identical with the sample). The panel evaluates the degree of similarity between both samples with 2.8 out of 3.0 scale points.

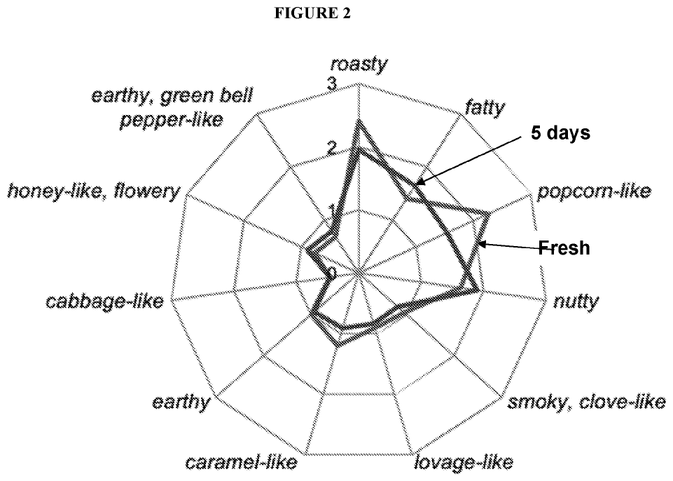

In further experiments, the influence of storage on the overall odor is investigated. A comparative analysis of the freshly and the 5 days stored roasted peanuts is implemented, to get an impression of the differences of the overall flavor. The results are shown in Table 4. Additionally, aroma profile analysis of freshly roasted and 5 days stored peanuts is illustrated in FIG. 2.

TABLE 4
Important odorants of the neutral-basic and acidic fraction of the freshly (f) roasted
compared to the 5 days (5 d) stored roasted high oleic acid peanuts (HOAP)

| | odor | odor | | | FD ^{f} | FD ^{f} |
|---|---|---|---|---|---|---|
| No. ^{a} | compounds _{b} | quality _{c} | RI_{FFAP} _{^{d}} | RI_{DB-5} _{^{e}} | (f) | (5 d) |
| 1 | 3-methylbutanal | malty | 922 | 669 | 256 | 128 |
| 2 | 2-methylbutanal | malty | 933 | 677 | 64 | 64 |
| 3 | 2,3-butanedione | buttery | 989 | 600 | 128 | 64 |
| 4 | 2,3-pentanedione | buttery | 1061 | 700 | 64 | 16 |
| 5 | hexanal | green, grassy | 1083 | 804 | 64 | 64 |
| 6 | (Z)-3-hexenal | green, grassy | 1111 | 819 | 16 | 8 |
| 7 | octanal | citrus-like, fatty | 1287 | 1007 | 16 | 16 |
| 8 | 1-octen-3-one | mushroom-like | 1296 | 979 | 64 | 64 |
| 9 | 2,5-dimethylpyrazine | earthy, roasty | 1317 | 917 | 64 | 32 |
| 10 | 2,6-dimethylpyrazine | earthy | 1322 | 910 | 32 | 16 |
| 11 | 2-acetyl-1-pyrroline | roasty, popcorn-like | 1326 | 921 | 2048 | 512 |
| 12 | ^{g} | citrus-like | 1335 | | 32 | 8 |
| 13 | 2,3-dimethylpyrazine | earthy, musty | 1343 | 914 | 128 | 64 |
| 14 | dimethyl trisulfide | cabbage-like | 1365 | 972 | 128 | 512 |
| 15 | 2-ethyl-5-methylpyrazine | earthy | 1383 | 1000 | 16 | 8 |
| 16 | nonanal | citrus-like, soapy | 1387 | 1104 | 128 | 128 |
| 17 | 2,3,5-trimethylpyrazine | earthy, roasty | 1396 | 1004 | 1024 | 512 |
| 18 | 2-propionyl-1-pyrroline | roasty, popcorn-like | 1417 | 1025 | 2048 | 2048 |
| 19 | 2-isopropyl-3-methoxypyrazine | pea-like, earthy, green bell | 1426 | 1096 | 1024 | 1024 |
| | | pepper-like | | | | |
| 20 | 2-furfurylthiol | coffee-like | 1430 | 910 | 64 | 32 |
| 21 | 2-ethyl-3,5-dimethylpyrazine | earthy | 1435 | 1079 | 512 | 512 |
| 22 | acetic acid ₕ | vinegar-like | 1445 | 608 | 32 | 32 |
| 23 | 3-ethyl-2,5-dimethylpyrazine | earthy | 1448 | 1082 | 64 | 64 |
| 24 | 3-(methylthio)-propanal | cooked potato-like | 1452 | 903 | 2048 | 2048 |
| 25 | furfural | sweet, cereal-like | 1465 | 832 | 128 | 32 |
| 26 | 2,3-diethyl-5-methylpyrazine | earthy | 1487 | 1157 | 2048 | 2048 |
| 27 | 2-(sec-butyl)-3-methoxypyrazine | earthy, green bell | 1491 | 1171 | 128 | 128 |
| | | pepper-like | | | | |
| 28 | (Z)-2-nonenal | fatty, leaf-like | 1496 | 1146 | 64 | 64 |
| 29 | 2-isobutyl-3-methoxypyrazine | bell pepper-like, earthy | 1514 | 1182 | 32 | 32 |
| 30 | 2-ethenyl-3,5-dimethylpyrazine | earthy | 1527 | 1100 | 32 | 16 |
| 31 | (E)-2-nonenal | fatty, green | 1545 | 1161 | 64 | 64 |
| 32 | 2-acetyl-(3,4,5,6)- | roasty, popcorn-like | 1550 | 1086 | 128 | 128 |
| 33 | 1-octanol | citrus, soapy | 1555 | 1079 | 64 | 64 |
| 34 | 2-acetyl-(1,4,5,6)- | roasty, popcorn-like | 1561 | 1140 | 1024 | 1024 |
| 35 | 2-acetylpyridine | roasty | 1577 | 1030 | 2048 | 2048 |
| 36 | 2-acetylpyrazine | sweet, roasty, popcorn- | 1586 | 1029 | 4096 | 2048 |
| | | like | | | | |
| 37 | (E)-2-decenal | fatty | 1615 | 1260 | 64 | 64 |
| 38 | phenylacetaldehyde | honey-like, flowery | 1645 | 1050 | 512 | 512 |
| 39 | 2- and 3-methylbutanoic acid ₕ | fruity, sweaty | 1665 | 875 | 16 | 16 |
| 40 | furfurylalcohol | sweet | 1668 | 1248 | 512 | 512 |
| 41 | 2-acetylthiazole | roasty | 1670 | 1014 | 16 | 16 |
| 42 | (E,E)-2,4-nonadienal | fatty, green | 1700 | 1224 | 8 | 16 |
| 43 | geranial _{g} | citrus-like | 1715 | 1244 | 16 | 16 |
| 44 | (E)-2-undecenal ₕ | metallic, fatty, | 1739 | 1358 | 32 | 32 |
| | | soapy, green | | | | |
| 45 | (E,E)-2,4-decadienal | deep-fried, fatty | 1805 | 1300 | 8 | 8 |
| 46 | 2-hydroxy-3-methyl-2-cyclopenten- | spicy | 1829 | 1032 | 16 | 16 |
| | 1-one ^{h} | | | | | |
| 47 | 2-methoxyphenol ₕ | smoky, sweet | 1858 | 1093 | 128 | 128 |
| 48 | 2-phenylethanol | flowery, honey-like | 1906 | 1107 | 64 | 64 |
| 49 | 3-hydroxy-2-methylpyran-4-one | caramel-like | 1974 | 1110 | 16 | 16 |
| 50 | γ-nonalactone | coconut-like | 2011 | 1363 | 16 | 16 |
| 51 | 4-hydroxy-2,5-dimethyl- | caramel-like | 2032 | 1071 | 4096 | 4096 |
| | 3(2H)-furanone ^{h} | | | | | |
| 52 | 3-hydroxy-4,5-dimethyl- | lovage-like | 2200 | 1107 | 1024 | 1024 |
| | 2(5H)-furanone ^{h} | | | | | |
| 53 | 2-methoxy-4-vinylphenol | smoky, clove-like | 2193 | 1317 | 4096 | 2048 |
| 54 | decanoic acid ₕ | soapy, musty | 2265 | 1388 | 64 | 32 |
| 55 | phenyl acetic acid ₕ | honey-like, beeswax- | 2553 | 1254 | 128 | 16 |
| | | like | | | | |
| 56 | 4-hydroxy-3-methoxy-benzaldehyde | vanilla-like, sweet | 2569 | 1404 | 128 | 64 |
| 57 | 3-phenylpropionic acid ₕ | flowery, cinnamon-like | 2633 | 1342 | 8 | 8 |

^{a} The detected odorants are consecutively numbered.
_{b} The compound is identified by comparing its mass spectra (MS-EI, MS-CI), retention indices on capillaries FFAP and DB-5 as well as the odor quality during sniffing with data of reference compounds.
_{c} Odor quality taken out of the database from the Leibniz-LSB@TUM.
^{d} Retention index on FFAP-column.
^{e} Retention index on DB-5-column.
^{f} Flavor dilution factor determined by AEDA on capillary FFAP.
^{g} No unequivocal mass spectra is obtained. Identification is based on the remaining criteria given in footnote b.
ₕ acidic Fraction

For the SHA of the 5 days stored roasted peanuts, the same compounds as for the freshly roasted peanuts are identified (Table 5). The sulfury smelling methanethiol and the malty smelling methylpropanal show a decrease of one FD-factor for the 5 days stored peanuts.

TABLE 5
Key odorants of freshly (f) roasted peanuts
and 5 days (5 d) stored roasted high oleic
acid peanuts (HOAP) by means of headspace-GC-O

| | | odor | | | |
|---|---|---|---|---|---|
| No. | odorant^{a} | quality^{b} | RI_{DB-5}_{^{c}} | FD^{d} (f) | FD^{d} (5 d) |
| 1 | hydrogen sulfide ₑ | sulfury | 446 | 2 | 2 |
| 2 | methanethiol ₑ | sulfury | 510 | 64 | 32 |
| 3 | dimethyl sulfide | cabbage-like | 594 | 1 | 1 |
| 4 | methylpropanal | malty | 631 | 64 | 32 |

^{a}The compound is identified by comparing its mass spectra (MS-EI), retention indices on capillary DB-5 as well as the odor quality during sniffing with data of reference compounds.
^{b}Odor quality taken out of the database from the Leibniz-LSB@TUM.
^{c}Retention index on DB-5-column.
^{d}Flavor dilution factor determined by SH-AEDA on capillary DB-5.
ₑ The compound is identified by the odor quality during sniffing.

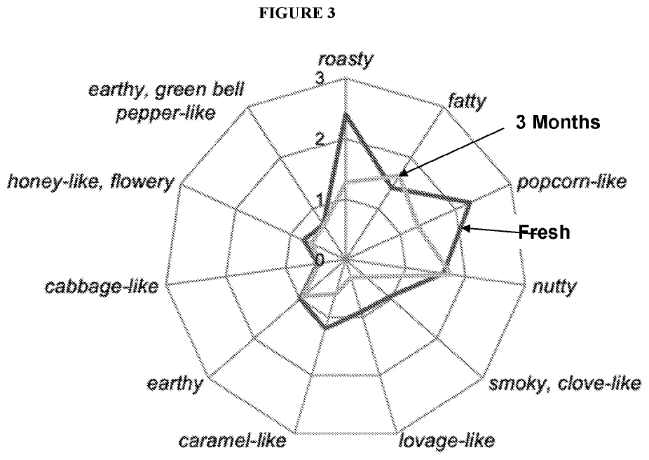

Moreover, a comparative analysis of the freshly and the 3 months stored roasted peanuts is implemented, the results of which are shown in Table 6. Additionally, aroma profile analysis of freshly roasted and 3 months stored peanuts is illustrated in FIG. 3.

TABLE 6
Important odorants of the neutral-basic and acidic fraction of the freshly (f) roasted
compared to the 3 months (3 m) stored roasted high oleic acid peanuts (HOAP)

| | | | | | | FD^{f} |
|---|---|---|---|---|---|---|
| | | odor | | | FD^{f} | (3 m) |
| No.^{a} | odorant ^{b} | quality ^{c} | RIFFAP^{d} | RIDB-5^{e} | (f) | [symbol] |
| 1 | 3-methylbutanal | malty | 938 | 650 | 256 | 64 |
| 2 | 2-methylbutanal | malty | 944 | 657 | 64 | 16 |
| 3 | 2,3-butanedione | buttery | 988 | 607 | 128 | 64 |
| 4 | 2,3-pentanedione | buttery | 1059 | 700 | 64 | — |
| 5 | hexanal | green, grassy | 1082 | 800 | 64 | 1024 |
| 6 | (Z)-3-hexenal | green, grassy | 1143 | 807 | 16 | 8 |
| 7 | octanal | citrus-like, fatty | 1287 | 1007 | 16 | 64 |
| 8 | 1-octen-3-one | mushroom-like | 1300 | 976 | 64 | 1024 |
| 9 | 2,5-dimethylpyrazine | earthy, roasty | 1322 | 910 | 64 | 32 |
| 10 | 2,6-dimethylpyrazine | earthy | 1326 | 907 | 32 | 16 |
| 11 | 2-acetyl-1-pyrroline | roasty, popcorn-like | 1330 | 924 | 2048 | 512 |
| 12 | ^{g} | citrus-like | 1335 | | 32 | 8 |
| 13 | 2,3-dimethylpyrazine | earthy, musty | 1339 | 914 | 128 | 16 |
| 14 | dimethyl trisulfide | cabbage-like | 1374 | 969 | 128 | 512 |
| 15 | 2-ethyl-5-methylpyrazine | earthy | 1387 | 1000 | 16 | 8 |
| 16 | nonanal | citrus-like, soapy | 1391 | 1100 | 128 | 64 |
| 17 | 2,3,5-trimethylpyrazine | earthy, roasty | 1400 | 1010 | 1024 | 256 |
| 18 | 2-propionyl-1-pyrroline | roasty, popcorn-like | 1418 | 1028 | 2048 | 64 |
| 19 | 2-isopropyl-3-methoxypyrazine | pea-like, earthy, green | 1427 | 1093 | 1024 | 1024 |
| | | bell pepper-like | | | | |
| 20 | 2-furfurylthiol | coffee-like | 1436 | 903 | 64 | 16 |
| 21 | 2-ethyl-3,5-dimethylpyrazine | earthy | 1441 | 1079 | 512 | 512 |
| 22 | acetic acid ^{h} | vinegar-like | 1445 | 614 | 32 | 32 |
| | 3-ethyl-2,5-dimethylpyrazine | earthy | 1455 | 1079 | 64 | 256 |
| | 3-(methylthio)-propanal | cooked potato-like | 1459 | 900 | 2048 | 2048 |
| 25 | furfural | sweet, cereal-like | 1468 | 828 | 128 | 32 |
| 26 | 2,3-diethyl-5-methylpyrazine | earthy | 1486 | 1158 | 2048 | 2048 |
| 27 | 2-(sec-butyl)-3-methoxypyrazine | earthy, green bell | 1495 | 1181 | 128 | — |
| | | pepper-like | | | | |
| 28 | (Z)-2-nonenal | fatty, leaf-like | 1500 | 1142 | 64 | 64 |
| 29 | 2-isobutyl-3-methoxypyrazine | bell pepper-like, | 1526 | 1185 | 32 | 32 |
| | | earthy | | | | |
| 30 | 2-ethenyl-3,5-dimethylpyrazine | earthy | 1535 | 1090 | 32 | — |
| 31 | (E)-2-nonenal | fatty, green | 1543 | 1162 | 64 | 128 |
| 32 | 2-acetyl-(3,4,5,6)- | roasty, popcorn-like | 1552 | 1079 | 128 | 128 |
| | tetrahydropyridine | | | | | |
| 33 | 1-octanol | citrus, soapy | 1557 | 1072 | 64 | 32 |
| 34 | 2-acetyl-(1,4,5,6)- | roasty, popcorn-like | 1561 | 1140 | 1024 | 128 |
| | tetrahydropyridine | | | | | |
| 35 | 2-acetylpyridine | roasty | 1565 | 1030 | 2048 | — |
| 36 | 2-acetylpyrazine | sweet, roasty, | 1591 | 1021 | 4096 | 32 |
| | | popcorn-like | | | | |
| 37 | (E)-2-decenal | fatty | 1617 | 1254 | 64 | 64 |
| 38 | (E,Z)-2,4-nonadienal | green, fatty | 1630 | 1196 | — | 16 |
| 39 | phenylacetaldehyde | honey-like, flowery | 1644 | 1045 | 512 | 8 |
| 40 | 2- and 3-methylbutanoic acid ^{h} | fruity, sweaty | 1661 | 876 | 16 | 16 |
| 41 | furfurylalcohol | sweet | 1661 | 1248 | 512 | 512 |
| 42 | 2-acetylthiazole | roasty | 1667 | 1014 | 16 | — |
| 43 | (E,E)-2,4-nonadienal | fatty, green | 1700 | 1219 | 8 | 16 |
| 44 | geranial ^{g} | citrus-like | 1711 | 1262 | 16 | 16 |
| 45 | pentanoic acid | sweaty, fruity | 1730 | 914 | — | 128 |
| 46 | (E)-2-undecenal ^{h} | metallic, fatty, soapy, | 1732 | 1363 | 32 | 128 |
| 47 | (E,Z)-2,4-decadienal | green | 1758 | 1296 | — | 16 |
| | | deep-fried, fatty | | | | |
| 48 | (E,E)-2,4-decadienal | deep-fried, fatty | 1800 | 1317 | 8 | 8 |
| 49 | 2-hydroxy-3-methyl-2- | spicy | 1833 | 1024 | 16 | — |
| | cyclopenten-1-one ^{h} | | | | | |
| 50 | hexanoic acid | sweaty | 1839 | 1014 | — | 64 |
| 51 | 2-methoxyphenol ^{h} | smoky, sweet | 1860 | 1090 | 128 | 256 |
| 52 | 2-phenylethanol | flowery, honey-like | 1906 | 1117 | 64 | 8 |
| 53 | γ-octalactone | coconut-like | 1924 | 1265 | — | 16 |
| 54 | 3-hydroxy-2-methylpyran-4-one | caramel-like | 1976 | 1118 | 16 | 16 |
| 55 | 6-octalactone | coconut-like | 1982 | 1277 | — | 16 |
| 56 | trans-4,5-epoxy-(E)-2-decenal | metallic, green | 2006 | 1383 | — | 2048 |
| 57 | γ-nonalactone | coconut-like | 2024 | 1350 | 16 | — |
| 58 | 4-hydroxy-2,5-dimethyl-3(2H)- | caramel-like | 2029 | 1071 | 4096 | 8 |
| | furanone ^{h} | | | | | |
| 59 | 6-nonalactone | coconut-like | 2088 | 1375 | — | 16 |
| 60 | 3-hydroxy-4,5-dimethyl-2(5H)- | lovage-like | 2200 | 1108 | 1024 | 512 |
| | furanone ^{h} | | | | | |
| 61 | 2-methoxy-4-vinylphenol | smoky, clove-like | 2200 | 1321 | 4096 | 512 |
| 62 | decanoic acid ^{h} | soapy, musty | 2260 | 1371 | 64 | 32 |
| 63 | phenylacetic acid ^{h} | honey-like, beeswax- | 2557 | 1262 | 128 | 16 |
| | | like | | | | |
| 64 | 4-hydroxy-3-methoxy- | vanilla-like, sweet | 2564 | 1404 | 128 | 32 |
| | benzaldehyde ^{h} | | | | | |
| 65 | 3-phenylpropionic acid ^{h} | flowery, cinnamon- | 2636 | 1338 | 8 | 8 |
| | | like | | | | |

^{a}The detected odorants were consecutively numbered.
^{b} The compound was identified by comparing its mass spectra (MS-EI, MS-CI), retention indices on capillaries FFAP and DB-5 as well as the odor quality during sniffing with data of reference compounds.
^{c} Odor quality taken out of the database from the Leibniz-LSB@TUM.
^{d}Retention index on FFAP-column.
^{e}Retention index on DB-5-column.
^{f}Flavor dilution factor determined by AEDA on capillary FFAP.
^{g} No unequivocal mass spectra was obtained. Identification is based on the remaining criteria given in footnote b.
^{h} acidic Fraction [symbol]
indicates data missing or illegible when filed

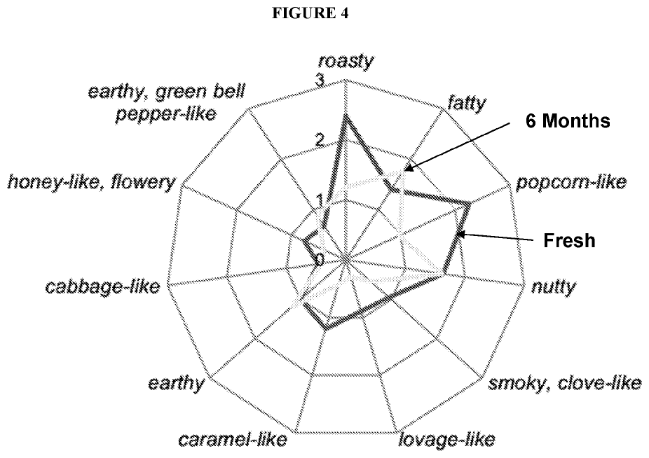

A comparative analysis of the freshly and the 6 months stored roasted peanuts was implemented, the results of which are shown in Table 7. Additionally, aroma profile analysis of freshly roasted and 6 months stored peanuts was illustrated in FIG. 4.

TABLE 7
Concentrations of the important odorants in 6 months
stored (6 m) roasted high oleic acid peanuts (HOAP)

| | concentration [μg/kg] | | | |
|---|---|---|---|---|
| odor compound | average ₐ | range _{b} | n _{c} | RSD [%] ^{d} |
| acetic acid | 24629 | 22930-25659 | 3 | 6 |
| hexanal | 15399 | 14669-16215 | 3 | 5 |
| hydrogen sulfide | 4941 | 4304-5344 | 3 | 11 |
| nonanal | 2973 | 2747-3162 | 3 | 7 |
| methylpropanal | 2383 | 2193-2599 | 3 | 9 |
| octanal | 2242 | 2197-2329 | 3 | 3 |
| hexanoic acid | 2085 | 1871-2416 | 3 | 14 |
| 2-methoxy-4-vinylphenol | 1425 | 1377-1458 | 3 | 3 |
| decanoic acid | 1120 | 970-1271 | 3 | 19 |
| pentanoic acid | 1008 | 959-1081 | 3 | 6 |
| (E,Z)-2,4-nonadienal | 880 | 783-976 | 2 | 16 |
| 2,3,5-trimethylpyrazine | 769 | 704-813 | 3 | 7 |
| (E)-2-decenal | 766 | 750-794 | 3 | 3 |
| methanethiol | 564 | 502-642 | 3 | 13 |
| furfurylalcohol | 416 | 405-424 | 3 | 2 |
| (E)-2-undecenal | 377 | 369-391 | 3 | 3 |
| 2,5-dimethylpyrazine | 281 | 247-336 | 3 | 17 |
| 1-octanol | 223 | 180-251 | 3 | 17 |
| 2,3-dimethylpyrazine | 207 | 204-214 | 3 | 3 |
| 2-methylbutanoic acid | 162 | 159-166 | 3 | 2 |
| 2-methylbutanal | 144 | 137-150 | 3 | 5 |
| furfural | 136 | 135-137 | 3 | 1 |
| 2,3-diethyl-5- | 110 | 107-111 | 3 | 2 |
| methylpyrazine | | | | |
| 4-hydroxy-2,5-dimethyl- | 106 | 96.5-120 | 3 | 12 |
| 3(2H)-furanone | | | | |
| 2-phenylethanol | 106 | 95.2-112 | 3 | 9 |
| phenylacetic acid | 99.1 | 96.5-104 | 3 | 4 |
| 3-methylbutanal | 98.8 | 97.9-100 | 3 | 1 |
| 3-methylbutanoic acid | 88.1 | 84.9-89.8 | 3 | 3 |
| 2,3-butanedione | 87.9 | 76.3-97.3 | 3 | 12 |
| 2-acetylpyrazine | 82.8 | 82.5-83.3 | 3 | 1 |
| 4-hydroxy-3-methoxy- | 79.8 | 70.3-89.7 | 3 | 12 |
| benzaldehyde | | | | |
| (E)-2-nonenal | 79.5 | 75.4-81.6 | 3 | 5 |
| phenylacetaldehyde | 69.6 | 63.6-74.6 | 3 | 8 |
| 3-ethyl-2,5- | 38.0 | 31.1-42.8 | 3 | 16 |
| dimethylpyrazine | | | | |
| 2,3-pentanedione | 34.7 | 32.3-37.1 | 3 | 7 |
| (Z)-2-decenal | 33.7 | 33.1-34.2 | 2 | 2 |
| dimethyl trisulfide | 29.1 | 27.3-30.7 | 3 | 6 |
| 2-ethyl-3,5- | 21.6 | 21.1-22.0 | 3 | 3 |
| dimethylpyrazine | | | | |
| 2-methoxpyhenol | 21.6 | 21.6-21.7 | 3 | 0 |
| 2-acetyl-(3,4,5,6)- | 18.2 | 16.1-21.3 | 3 | 15 |
| tetrahydropyridine | | | | |
| δ-nonalactone | 15.2 | 14.0-16.4 | 2 | 11 |
| 3-(methylthio)-propanal | 15.1 | 14.4-16.2 | 3 | 7 |
| 2-propionyl-1-pyrroline | 15.0 | 13.7-16.5 | 3 | 10 |
| 1-octen-3-one | 14.6 | 14.2-15.0 | 3 | 3 |
| 2-acetylpyridine | 14.1 | 13.6-15.0 | 3 | 5 |
| 3-hydroxy-4,5-dimethyl- | 9.36 | 8.85-10.2 | 3 | 8 |
| 2(5H)-furanone | | | | |
| 2-furfurylthiol | 8.11 | 7.79-8.33 | 3 | 4 |
| (Z)-2-nonenal | 7.59 | 6.87-8.31 | 2 | 13 |
| 2-(sec-butyl)-3- | 5.17 | 5.01-5.34 | 3 | 3 |
| methoxypyrazine | | | | |
| 2-isopropyl-3- | 4.94 | 4.90-4.97 | 3 | 1 |
| methoxypyrazine | | | | |
| 2-isobutyl-3- | 4.29 | 4.25-4.33 | 3 | 1 |
| methoxypyrazine | | | | |
| 2-acetyl-(1,4,5,6)- | 3.25 | 3.24-3.25 | 2 | 0 |
| tetrahydropyridine | | | | |
| 2-acetyl-1-pyrroline | 3.21 | 3.05-3.37 | 3 | 5 |

ₐ Average values are calculated from n determinations.
_{b} The range shows the smallest and the highest concentration measured within n determinations.
_{c} Number of determinations.
^{d} Relative standard deviation (RSD).

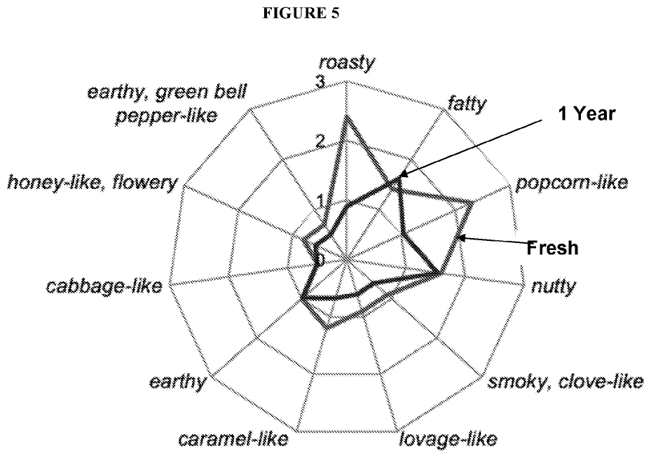

A comparative analysis of the freshly and the 1 year stored roasted peanuts is implemented, the results of which are shown in Table 8. Additionally, aroma profile analysis of freshly roasted and one year stored peanuts is illustrated in FIG. 5.

TABLE 8
Concentrations of the important odorants in 1 year
stored (1 y) roasted high oleic acid peanuts (HOAP)

| | concentration [μg/kg] | | | |
|---|---|---|---|---|
| odor compound | average ₐ | range ^{b} | n ^{c} | RSD [%] ^{d} |
| acetic acid | 21855 | 20680-23889 | 3 | 8 |
| hexanal | 16476 | 14349-19095 | 3 | 15 |
| hexanoic acid | 4267 | 4178-4424 | 3 | 3 |
| octanal | 3794 | 3452-4138 | 3 | 9 |
| hydrogen sulfide | 3020 | 2951-3084 | 3 | 2 |
| nonanal | 2842 | 2496-3288 | 3 | 14 |
| pentanoic acid | 2276 | 2035-2414 | 3 | 9 |
| methylpropanal | 1987 | 1847-2082 | 3 | 6 |
| (E,Z)-2,4-nonadienal | 1915 | 1694-2029 | 3 | 10 |
| 2,3,5-trimethylpyrazine | 886 | 758-966 | 3 | 13 |
| (E)-2-undecenal | 628 | 598-673 | 3 | 6 |
| methanethiol | 491 | 427-542 | 3 | 12 |
| (E)-2-dcccnal | 448 | 413-492 | 3 | 9 |
| decanoic acid | 423 | 363-480 | 3 | 14 |
| 2-methoxy-4-vinylphenol | 385 | 357-406 | 3 | 7 |
| 3-methylbutanoic acid | 258 | 248-265 | 3 | 3 |
| 1-octanol | 200 | 219-293 | 3 | 13 |
| furfurylalcohol | 199 | 188-209 | 3 | 5 |
| 2-methylbutanoic acid | 187 | 183-191 | 3 | 2 |
| phenylacetic acid | 146 | 143-149 | 3 | 2 |
| 2,5-dimethylpyrazine | 140 | 120-160 | 3 | 14 |
| (E)-2-nonenal | 111 | 107-113 | 3 | 3 |
| 2-methylbutanal | 95.0 | 90.6-103 | 3 | 7 |
| 3-methylbutanal | 81.7 | 79.3-83.4 | 3 | 3 |
| 2-phenylethanol | 80.4 | 79.5-81.7 | 3 | 1 |
| 2,3-dimethylpyrazine | 72.8 | 68.4-78.4 | 3 | 7 |
| 2-acetylpyrazine | 64.7 | 58.3-74.8 | 3 | 14 |
| furfural | 64.1 | 61.3-66.1 | 3 | 4 |
| 1-octen-3-one | 58.0 | 55.6-59.6 | 3 | 4 |
| 2,3-butanedione | 57.7 | 55.3-60.2 | 2 | 6 |
| 4-hydroxy-3-methoxy- | 53.4 | 49.4-61.2 | 3 | 13 |
| benzaldehyde | | | | |
| 2-ethyl-3,5- | 45.0 | 39.7-50.5 | 3 | 12 |
| dimethylpyrazine | | | | |
| phenylacetaldehyde | 44.7 | 43.6-45.7 | 3 | 2 |
| 4-hydroxy-2,5- | 43.7 | 41.5-45.0 | 3 | 5 |
| dimethyl-3(2H)- | | | | |
| (Z)-2-decenal | 33.0 | 29.7-36.6 | 3 | 11 |
| 3-ethyl-2,5- | 32.9 | 30.5-35.3 | 3 | 10 |
| dimethylpyrazine | | | | |
| 2,3-diethyl-5- | 20.8 | 19.4-22.5 | 3 | 8 |
| methylpyrazine | | | | |
| 3-(methylthio)-propanal | 19.6 | 19.3-20.3 | 3 | 3 |
| 2,3-pentanedione | 17.3 | 16.5-18.1 | 3 | 5 |
| 2-methoxpyhenol | 16.6 | 16.3-16.7 | 3 | 1 |
| δ-nonalactone | 15.0 | 14.8-16.2 | 3 | 7 |
| (Z)-2-nonenal | 11.6 | 11.2-12.0 | 3 | 5 |
| 2-isopropyl-3- | 11.0 | 10.9-11.0 | 3 | 0 |
| methoxypyrazine | | | | |
| dimethyl trisulfide | 9.84 | 9.59-10.1 | 3 | 3 |
| 2-propionyl-1-pyrroline | 8.83 | 7.56-9.73 | 3 | 13 |
| 2-acetylpyridine | 8.06 | 7.85-8.22 | 3 | 2 |
| 3-hydroxy-4,5- | 7.29 | 6.74-7.88 | 3 | 8 |
| dimethyl-2(5H)- | | | | |
| 2-furfurylthiol | 7.10 | 6.95-7.25 | 3 | 2 |
| 2-isobutyl-3- | 4.76 | 4.69-4.90 | 3 | 2 |
| methoxypyrazine | | | | |
| 2-(sec-butyl)-3- | 4.76 | 4.72-4.78 | 3 | 1 |
| methoxypyrazine | | | | |
| 2-acetyl-1-pyrroline | 2.83 | 2.59-2.96 | 3 | 7 |
| 2-acetyl-(1,4,5,6)- | 2.22 | 2.01-2.57 | 3 | 14 |
| tetrahydropyridine | | | | |
| 2-acetyl-(3,4,5,6)- | 0.79 | 0.78-0.79 | 2 | 1 |
| tetrahydropyridine | | | | |

ₐ Average values are calculated from n determinations.
^{b} The range shows the smallest and the highest concentration measured within n determinations.
^{c} Number of determinations.
^{d} Relative standard deviation (RSD).

Table 9 shows selected aroma compounds showing a significant decrease in the concentrations from freshly roasted peanuts to 6 months and 1 year stored roasted peanuts. The most remarkable descent of the concentration after a storage of one year is recognizable for the popcorn-like, roasty smelling 2-acetyl-(3,4,5,6)-tetrahydropyridine, followed by the buttery 2,3-pentanedione and the honey-like, flowery phenylacetaldehyde.

TABLE 9
Concentrations of the most decreasing odorants from
freshly (f) roasted, to 6 months (6 m) and to 1
year (1 y) stored roasted high oleic acid peanuts

| | concentration [μg/kg] | | |
|---|---|---|---|
| odorant | (f) | (6 m) | (1 y) |
| 2-acetyl-(3,4,5,6)-tetrahydropyridine | 187 | 18.2 | 0.79 |
| 2,3-pentanedione | 2759 | 34.7 | 17.3 |
| phenylacetaldehyde | 5260 | 69.6 | 44.7 |
| 2-acetyl-(1,4,5,6)-tetrahydropyridine | 176 | 3.21 | 2.22 |
| 4-hydroxy-2,5-dimethyl-3(2H)-furanone | 3401 | 106 | 43.7 |
| 2-methylbutanal | 4883 | 144 | 95.0 |
| 2,3-butanedione | 2770 | 87.9 | 57.7 |
| 3-methylbutanal | 2078 | 98.8 | 81.7 |
| 2-acetyl-1-pyrroline | 54.5 | 3.25 | 2.83 |
| 2-ethyl-3,5-dimethylpyrazine | 299 | 25.0 | 45.0 |
| 2-methoxy-4-vinylphenol | 2315 | 1425 | 385 |
| 2,3-diethyl-5-methylpyrazine | 121 | 110 | 20.8 |
| phenylacetic acid | 639 | 99.1 | 146 |
| 2-propionyl-1-pyrroline | 36.1 | 15.0 | 8.83 |
| 2-acetylpyrazine | 148 | 82.8 | 64.7 |

As a result of the roasting process some popcorn-like and roasty smelling compounds are determined in the aroma extract dilution analysis with FD-factors in a range between 128 and 4096. The identification experiments clarified that it is 2-acetyl-(1,4,5,6)-tetrahydropyridine and 2-acetyl-(3,4,5,6)-tetrahydropyridine, 2-acetyl-1-pyrroline, 2-propionyl-1-pyrroline and 2-acetylpyrazine. In the comparative AEDA of a freshly roasted sample and a sample stored for 1 year, these aroma compounds are determined only with an FD-factor of 8 or are not perceivable anymore in the stored sample. In the freshly roasted peanuts, a content of 187 μg/kg is determined for 2-acetyl-(3,4,5,6)-tetrahydropyridine and a content of 176 μg/kg for 2-acetyl-(1,4,5,6)-tetrahydropyridine, whereas concentrations of 0.79 μg/kg and 2.22 μg/kg are quantified after one year of storage. 2-acetyl-(3,4,5,6)-tetrahydropyridine thus shows the highest decrease during storage. Even 2-acetyl-1-pyrroline shows a decrease in concentration due to storage from 54.5 μg/kg to 2.83 μg/kg, as well as 2-propionyl-1-pyrroline from 36.1 μg/kg to 8.83 μg/kg and 2-acetylpyrazine from 148 μg/kg to 64.7 μg/kg. The decrease of these popcorn-like, roasty smelling compounds illustrates how important these odorants are for the roasty smelling odor impression of freshly roasted peanuts. Among these roasty compounds 2-acetyl-1-pyrroline with an OAV of 1028 is identified as the main aroma compound for this group of odorants, with also high OAV's of 549 and 515 followed 2-acetyl-(1,4,5,6)-tetrahydropyridine and 2-propionyl-1-pyrroline. 2-acetylpyrazine does not seem to play a huge role among the roasty smelling compounds with an OAV of 9.

High concentrations in freshly roasted peanuts are also determined for the buttery smelling diketones 2,3-pentanedione and 2,3-butanedione. A comparison with the stored samples shows that the highly volatile compounds decreased by a factor of 159 for 2,3-pentanedione and by a factor of 48 for 2,3-butanedione within one year of storage. Both odorants show with an OAV of 3066 (2,3-butanedione) and an OAV of 616 (2,3-pentanedione) that they make a big contribution to the aroma of freshly roasted peanuts. Even if a large decrease in concentration is determined, both buttery aroma compounds contribute to the overall flavor of stored peanuts even after one year of storage, suggesting an OAV of 64 for 2,3-butanedione and an OAV of 4 for 2,3-pentanedione.

Another odorant that is quantified in a remarkably high concentration in freshly roasted peanuts is the honey-like, flowery smelling phenylacetaldehyde. In the freshly roasted sample a content of 5260 μg/kg is determined, after one year of storage only a concentration of 44.7 μg/kg is quantitated. An OAV of 155 for the freshly sample, for the 6 months stored sample an OAV of only 2 and after 1 year storage an OAV of 1 is calculated. For the other honey-like, beeswax-like smelling component phenylacetic acid a smaller decrease in concentration during storage is detected with contents of 639 μg/kg (freshly roasted) and 146 μg/kg (1 year stored). Also for the caramel-like smelling odorant 4-hydroxy-2,5-dimethyl-3(2H)-furanone a high content of 3401 μg/kg is determined for the freshly roasted peanuts, whereas after 6 months storage 106 μg/kg and after 1 year storage 43.7 μg/kg are quantitated. 4-hydroxy-2,5-dimethyl-3(2H)-furanone contributes to the overall flavor of the freshly roasted peanuts with an OAV of 126, after one year storage only an OAV of 2 is defined.

Further Strecker aldehydes, which is accessed by the roasting process in freshly roasted peanuts in high concentrations, were 2-methylbutanal and 3-methylbutanal. Both malty smelling Strecker aldehydes are also formed by Strecker degradation from their corresponding free amino acids. In the case of 2-methylbutanal from isoleucine and of 3-methylbutanal from leucine. For 2-methylbutanal a content of 4883 μg/kg (freshly roasted) and for 3-methylbutanal a content of 2078 μg/kg (freshly roasted) is quantified. After 6 months of storage only a concentration of 144 μg/kg and of 95.0 μg/kg after 1 year storage are detected for 2-methylbutanal. For 3-methylbutanal similar results are investigated. After 6 months of storage 98.8 μg/kg is detected and after a storage of one year a content of 81.7 μg/kg.

A variety of pyrazines are identified in freshly roasted peanuts. The concentrations of 2-ethyl-3,5-dimethylpyrazine and 2,3-diethyl-5-methylpyrazine show the highest decrease. 2-ethyl-3,5-dimethylpyrazine has a concentration of 299 μg/kg in freshly roasted peanuts and a content of 45.0 μg/kg after one year of storage. 2,3-diethyl-5-methylpyrazine decreases by a factor of 6 during one year storage.

Furthermore a decrease in concentration from 2315 μg/kg (freshly roasted) to 358 μg/kg (1 year stored) for the smoky, clove-like smelling 2-methoxy-4-vinylphenol was quantified.

One of the highest concentrations is detected for the highly volatile hydrogen sulfide with 7807 μg/kg in freshly roasted peanuts. After one year of storage a concentration of 3020 μg/kg is determined. Additionally, methanethiol with its sulfury flavor nearly halves from 901 μg/kg (freshly roasted) to 491 μg/kg (1 year stored) within one year. With an OAV of 2502 in freshly roasted peanuts and an OAV of 1364 in the one year stored peanuts methanethiol contributes a large share to the overall flavor of peanuts. The cabbage-like smelling dimethyl trisulfide is detected only in the freshly roasted peanuts with a concentration of 9.56 μg/kg compared to the two others sulfury smelling compounds. After 6 months storage a content of 29.1 μg/kg and after one year storage almost the same concentration as in the freshly roasted sample is quantified. These results are summarized in Table 10.

TABLE 10
Concentrations of the sulfury and cabbage-like smelling
compounds from freshly (f) roasted, to 6 months (6 m) and
to 1 year (1 y) stored roasted high oleic acid peanuts

| | concentration [μg/kg] | | |
|---|---|---|---|
| odorant | (f) | (6 m) | (1 y) |
| hydrogen sulfide | 7807 | 4941 | 3020 |
| methanethiol | 901 | 564 | 491 |
| dimethyl trisulfide | 9.56 | 29.1 | 9.84 |

### Example 2—Identification of Aroma Compounds in Low Oleic Acid Peanuts

Low oleic acid peanuts are raw and blanched samples from USA. Analytical methods described in Example 1 are also used in this example.

SH-GC-O is used to complete the AEDA in order to cover the highly volatile aroma compounds. Therefore, a sequenced series of decreasing gas volumes in the headspace of the roasted peanuts are analyzed. In this way three compounds for freshly roasted low oleic acid peanuts are perceived. The identification is done by comparing the mass spectra of the compounds recorded in the EI-mode and the odor quality with the corresponding reference compounds. The identified compounds are hydrogen sulfide, methanethiol and methylpropanal (Table 11). The malty smelling methylpropanal is analyzed as the most odor-active aroma compound, since this odorant is perceivable in a volume of 0.3 mL (FD 32), followed by the sulfury smelling methanethiol with an FD-factor of 16. The highly volatile hydrogen sulfide with a sulfury smelling (FD 2) is also identified.

TABLE 11
Key odorants of freshly (f) roasted low oleic
acid peanuts (LOAP) by means of headspace-GC-O

| | | odor | | | |
|---|---|---|---|---|---|
| No. | odorant^{a} | quality^{b} | RI_{DB-5}_{^{c}} | volume _{d} (mL) | FD^{e} (f) |
| 1 | hydrogen sulfide _{d} | sulfury | 440 | 5.00 | 2 |
| 2 | methanethiol _{d} | sulfury | 504 | 0.60 | 16 |
| 3 | methylpropanal | malty | 588 | 0.30 | 32 |

^{a}The compound is identified by comparing its mass spectra (MS-EI), retention indices on capillary DB-5 as well as the odor quality during sniffing with data of reference compounds.
^{b}Odor quality taken out of the database from the Leibniz-LSB@TUM.
^{c}Retention index on DB-5-column.
_{d} Relative Flavor dilution factor is calculated as the ratio of the highest analyzed volume and the lowest volume in which the odorant is still perceivable.
^{e}Flavor dilution factor determined by SH-AEDA.
^{f} The compound is identified by the odor quality during sniffing.

41 aroma-active compounds are quantified from the freshly roasted low oleic acid peanuts, the results of which are shown in Table 12.

TABLE 12
Concentrations of important odorants in freshly (f) roasted LOAP

| | concentration [μg/kg] | | | |
|---|---|---|---|---|
| odor compound | average ₐ | range _{b} | n ^{c} | RSD[%]^{d} |
| acetic acid | 21155 | 19842-22858 | 3 | 7 |
| hydrogen sulfide | 6032 | 5623-6456 | 3 | 7 |
| 2-methoxy-4-vinylphenol | 4910 | 4044-5344 | 3 | 15 |
| phenylacetaldehyde | 4808 | 4476-5071 | 3 | 6 |
| 4-hydroxy-2,5-dimethyl- | 3782 | 3651-4040 | 3 | 6 |
| 3(2H)-furanone | | | | |
| 2-methylbutanal | 3565 | 3518-3636 | 3 | 2 |
| methylpropanal | 3319 | 3088-3625 | 3 | 8 |
| nonanal | 1210 | 1172-1242 | 3 | 3 |
| 2,3-pentanedione | 1191 | 1156-1257 | 3 | 5 |
| 3-methylbutanal | 951 | 920-969 | 3 | 3 |
| 2,3,5-trimethylpyrazine | 854 | 779-916 | 3 | 8 |
| phenylacetic acid | 733 | 698-768 | 2 | 7 |
| 1-octanol | 596 | 507-686 | 2 | 21 |
| hexanoic acid | 564 | 531-603 | 3 | 6 |
| methanethiol | 571 | 514-616 | 3 | 9 |
| octanal | 525 | 481-591 | 3 | 11 |
| hexanal | 522 | 495-552 | 3 | 6 |
| furfurylalcohol | 297 | 288-313 | 3 | 5 |
| (E)-2-undecenal | 263 | 249-281 | 3 | 6 |
| furfural | 212 | 205-216 | 3 | 3 |
| 2-ethyl-3,5-dimethylpyrazine | 207 | 187-222 | 3 | 9 |
| 2-methylbutanoic acid | 164 | 154-172 | 3 | 6 |
| 3-methylbutanoic acid | 157 | 148-167 | 3 | 6 |
| 2,3-diethyl-5-methylpyrazine | 146 | 143-148 | 3 | 2 |
| 2-acetylpyrazine | 138 | 132-141 | 3 | 3 |
| 2-acetyl-(1,4,5,6)- | 129 | 108-150 | 2 | 23 |
| tetrahydropyridine | | | | |
| 2,3-butanedione | 126 | 111-141 | 2 | 17 |
| pentanoic acid | 85.5 | 82.7-90.1 | 3 | 5 |
| 3-(methylthio)-propanal | 78.5 | 76.0-81.2 | 3 | 3 |
| 2-acetyl-1-pyrroline | 34.1 | 33.3-35.2 | 3 | 3 |
| 2-propionyl-1-pyrroline | 32.5 | 29.3-35.1 | 3 | 9 |
| 2-methoxpyhenol | 29.4 | 29.3-29.4 | 3 | 0 |
| (Z)-2-nonenal | 25.4 | 23.3-27.7 | 3 | 9 |
| l-octen-3-one | 19.6 | 19.4-19.8 | 3 | 1 |
| 3-hydroxy-4,5-dimethyl- | 13.3 | 12.5-13.9 | 3 | 5 |
| 2(5H)-furanone | | | | |
| 2-furfurylthiol | 11.4 | 11.3-11.4 | 2 | 1 |
| 2-acetyl-(3,4,5,6)- | 10.6 | 8.48-11.9 | 3 | 18 |
| tetrahydropyridine | | | | |
| 2-isopropyl-3- | 10.5 | 9.58-11.9 | 3 | 12 |
| methoxypyrazine | | | | |
| 2-isobutyl-3- | 7.99 | 7.93-8.08 | 3 | 1 |
| methoxypyrazine | | | | |
| 2-(sec-butyl)-3- | 6.60 | 6.51-6.69 | 3 | 1 |
| methoxypyrazine | | | | |
| dimethyl trisulfide | 4.90 | 4.71-5.00 | 3 | 3 |

ₐ Average values are calculated from n determinations.
_{b} The range shows the smallest and the highest concentration measured within n determinations.
^{c} Number of determinations.
^{d}Relative standard deviation (RSD)

In the freshly roasted peanuts, a total number of 41 odor activity values are calculated, as shown in Table 13. 36 odorants showed OAVs ≥1, which indicates that these aroma compounds contributed to the overall flavor of the peanuts.

TABLE 13
Odor Activity Values of important odorants in freshly
(f) roasted low oleic acid peanuts (LOAP)

| odorant | OAV^{a} | OOT (μg/kg)^{b} |
|---|---|---|
| methanethiol | 1586 | 0.36 |
| 2-isopropyl-3-methoxypyrazine | 1052 | 0.01 |
| 2-acetyl-1-pyrroline | 644 | 0.053 |
| 2-furfurylthiol | 598 | 0.019 |
| 2-propionyl-1-pyrroline | 465 | 0.07 |
| 2-acetyl-(1,4,5,6)-tetrahydropyridine | 403 | 0.32 |
| 2,3-pentanedione | 265 | 4.5 |
| methylpropanal | 221 | 15 |
| 2-isobutyl-3-methoxypyrazine | 200 | 0.04 |
| dimethyl trisulfide | 163 | 0.03 |
| 3-(methylthio)-propanal | 151 | 0.52 |
| phenylacetaldehyde | 141 | 37 |
| 2,3-butanedione | 140 | 0.9 |
| 4-hydroxy-2,5-dimethyl-3(2H)-furanone | 140 | 27 |
| 2-ethyl-3,5-dimethylpyrazine | 122 | 1.7 |
| 2-methylbutanal | 105 | 34 |
| 3-methylbutanal | 63 | 15 |
| acetic acid | 60 | 350 |
| hydrogen sulfide | 60 | 100 |
| 3-hydroxy-4,5-dimethyl-2(5H)-furanone | 58 | 0.23 |
| 2-methoxy-4-vinylphenol | 50 | 98 |
| 1-octanol | 33 | 18 |
| phenylacetic acid | 28 | 26 |
| 2,3-diethyl-5-methylpyrazine | 20 | 7.2 |
| 2-methoxpyhenol | 16 | 1.8 |
| 3-methylbutanoic acid | 14 | 11 |
| 2-(sec-butyl)-3-methoxypyrazine | 14 | 0.46 |
| 2-acetylpyrazine | 9 | 16 |
| 2-acetyl-(3,4,5,6)-tetrahydropyridine | 9 | 1.2 |
| (Z)-2-nonenal | 7 | 3.6 |
| 2,3,5-trimethylpyrazine | 5 | 180 |
| octanal | 4 | 140 |
| hexanal | 2 | 300 |
| 2-methylbutanoic acid | 2 | 110 |
| nonanal | 2 | 610 |
| hexanoic acid | 1 | 460 |
| furfural | <1 | 28000 |
| furfurylalcohol | <1 | 700 |
| 1-octen-3-one | <1 | 61 |
| pentanoic acid | <1 | 400 |
| (E)-2-undecenal | <1 | 7700 |

^{a}Odor Activity Value.
^{b}Odor Threshold in sunflower oil.

Based on the quantitative data, an aroma model is prepared to simulate the aroma of the freshly roasted low oleic acid peanuts. 36 quantified aroma compounds have an odor activity value ≥1. These aroma compounds are dissolved in sunflower oil in the concentrations determined in the sample to prepare the aroma model. The recombinate is directly compared with the freshly roasted peanut sample. The panel evaluates the given odor impressions to an intensity of 0 to 3.

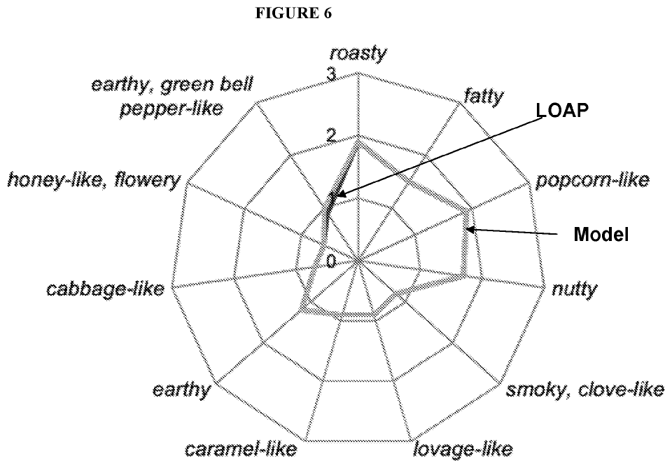

FIG. 6 shows only for the earthy, green bell pepper-like note a deviation of 0.1. The other aroma impressions are judged as identical in their aroma profiles. The panelists evaluate the peanuts as well to their similarity to the aroma recombination (0=no similarity, 1=low similarity, 2=food detected, 3=identical with the sample). The similarity between both samples is judged by the panel with 2.8 out of 3.0 scale points.

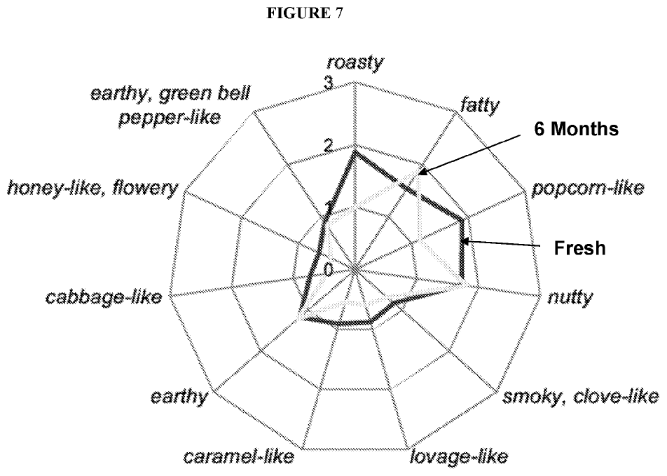

A comparative analysis of the freshly and the 6 months stored roasted peanuts is implemented, the results of which are shown in Tables 14-16. Additionally, aroma profile analysis of freshly roasted and 6 months stored peanuts is illustrated in FIG. 7.

TABLE 14
Important odorants of the neutral-basic and acidic fraction in distillates prepared
from freshly roasted and 6 months stored roasted low oleic acid peanuts (LOAP)

| No.^{a} | odorant^{b} | odor quality^{c} | RIFFAP^{d} | RIDB-5^{e} | FD ^{f} (f) | FD ^{f} (6 m) |
|---|---|---|---|---|---|---|
| 1 | 3-methylbutanal | malty | 922 | 650 | 256 | 32 |
| 2 | 2-methylbutanal | malty | 933 | 657 | 64 | 32 |
| 3 | 2,3-butanedione | buttery | 980 | 600 | 16 | 8 |
| 4 | 2,3-pentanedione | buttery | 1061 | 700 | 16 | — |
| 5 | hexanal | green, grassy | 1082 | 800 | 128 | 4096 |
| 6 | (Z)-3-hexenal | green, grassy | 1143 | 807 | 32 | 8 |
| 7 | octanal | citrus-like, fatty | 1287 | 1004 | 16 | 128 |
| 8 | 1-octen-3-one | mushroom-like | 1296 | 977 | 1024 | 1024 |
| 9 | 2,5-dimethylpyrazine | earthy, roasty | 1317 | 910 | 32 | 8 |
| 10 | 2,6-dimethylpyrazine | earthy | 1322 | 907 | 64 | 64 |
| 11 | 2-acetyl-1-pyrroline | roasty, popcorn-like | 1326 | 923 | 2048 | — |
| 12 | ^{g} | citrus-like | 1335 | | 16 | — |
| 13 | 2,3-dimethylpyrazine | earthy, musty | 1339 | 915 | 16 | — |
| 14 | dimethyl trisulfide | cabbage-like | 1365 | 969 | 128 | 512 |
| 15 | 2-ethyl-5-methylpyrazine | earthy | 1383 | 1000 | 16 | 8 |
| 16 | nonanal | citrus-like, soapy | 1387 | 1104 | 32 | 256 |
| 17 | 2,3,5-trimethylpyrazine | earthy, roasty | 1396 | 1004 | 64 | 64 |
| 18 | 2-propionyl-1-pyrroline | roasty, popcorn-like | 1417 | 1025 | 512 | 64 |
| 19 | 2-isopropyl-3- | pea-like, earthy, | 1427 | 1093 | 4096 | 2048 |
| | methoxypyrazine | green bell pepper- | | | | |
| | | like | | | | |
| 20 | 2-furfurylthiol | coffee-like | 1430 | 912 | 64 | 8 |
| 21 | 2-ethyl-3,5-dimethylpyrazine | earthy | 1435 | 1079 | 512 | 256 |
| 22 | acetic acid ^{h} | vinegar-like | 1445 | 608 | 64 | 64 |
| | 3-ethyl-2,5-dimethylpyrazine | earthy | 1448 | 1079 | 64 | 8 |
| | 3-(methylthio)-propanal | cooked potato-like | 1452 | 904 | 4096 | 512 |
| 25 | furfural | sweet, cereal-like | 1465 | 832 | 256 | 16 |
| 26 | 2,3-diethyl-5-methylpyrazine | earthy | 1479 | 1158 | 4096 | 256 |
| 27 | 2-(sec-butyl)-3- | earthy, green bell | 1495 | 1172 | 128 | 8 |
| | methoxypyrazine | pepper-like | | | | |
| 28 | (Z)-2-nonenal | fatty, leaf-like | 1496 | 1148 | 128 | 128 |
| 29 | 2-isobutyl-3- | bell pepper-like, | 1514 | 1185 | 256 | 64 |
| | methoxypyrazine | earthy | | | | |
| 30 | 2-ethenyl-3,5- | earthy | 1524 | 1092 | 8 | — |
| | dimethylpyrazine | | | | | |
| 31 | (E)-2-nonenal | fatty, green | 1533 | 1160 | 8 | 64 |
| 32 | 2-acetyl-(3,4,5,6)- | roasty, popcorn-like | 1550 | 1079 | 64 | 8 |
| | tetrahydropyridine | | | | | |
| 33 | 1-octanol | citrus, soapy | 1555 | 1072 | 128 | 64 |
| 34 | 2-acetyl-(1,4,5,6)- | roasty, popcorn-like | 1561 | 1081 | 512 | 8 |
| | tetrahydropyridine | | | | | |
| 35 | 2-acetylpyridine | roasty | 1581 | 1030 | 1024 | — |
| 36 | 2-acetylpyrazine | sweet, roasty, | 1591 | 1024 | 2048 | — |
| 37 | (E)-2-decenal | popcorn-like | 1617 | 1260 | 64 | 64 |
| | | fatty | | | | |
| 38 | (E,Z)-2,4-nonadienal | fatty, green | 1643 | 1192 | — | 128 |
| 39 | phenylacetaldehyde | honey-like, flower | 1644 | 1045 | 512 | 16 |
| 40 | 2- and 3-methylbutanoic acid ^{h} | fruity, sweaty | 1661 | 875 | 64 | 128 |
| 41 | furfurylalcohol | | 1665 | 1248 | 256 | 8 |
| 42 | 2-acetylthiazole | roasty | 1667 | 1014 | 8 | — |
| 43 | (E,E)-2,4-nonadienal | fatty, green | 1700 | 1213 | 8 | 32 |
| 44 | geranial ^{g} | citrus-like | 1711 | 1261 | 8 | — |
| 45 | pentanoic acid ^{h} | sweaty, fruity | 1732 | 914 | — | 256 |
| 46 | (E)-2-undecenal ^{h} | metallic, fatty, | 1739 | 1358 | 64 | 256 |
| | | soapy, green | | | | |
| 47 | (E,Z)-2,4-decadienal | deep-fried, fatty | 1758 | 1296 | 8 | 8 |
| 48 | (E,E)-2,4-decadienal | deep-fried, fatty | 1795 | 1317 | 16 | 16 |
| 49 | hexanoic acid ^{h} | sweaty | 1839 | 1014 | 16 | 512 |
| 50 | 2-methoxyphenol ^{h} | smoky, sweet | 1861 | 1090 | 128 | 256 |
| 51 | trans-4,5-epoxy-(E)-2- | metallic | 1876 | 1281 | — | 16 |
| | nonenal ⁱ | | | | | |
| 52 | 2-phenylethanol | flowery, honey-like | 1906 | 1117 | 8 | 16 |
| 53 | γ-octalactone | coconut-like | 1920 | 1269 | — | 16 |
| 54 | 3-hydroxy-2-methylpyran-4- | caramel-like | 1968 | 1100 | 8 | — |
| | one | | | | | |
| 55 | δ-octalactone | coconut-like | 1972 | 1281 | — | 16 |
| 56 | trans-4,5-epoxy-(E)-2- | metallic, green | 2006 | 1383 | 1024 | 4096 |
| 57 | γ-nonalactone | coconut-like | 2024 | 1363 | 8 | 16 |
| 58 | 4-hydroxy-2,5-dimethyl- | caramel-like | 2029 | 1071 | 4096 | 8 |
| | 3(2H)-furanone ^{h} | | | | | |
| 59 | 3-hydroxy-4,5-dimethyl- | lovage-like | 2193 | 1108 | 1024 | 512 |
| | 2(5H)-furanone ^{h} | | | | | |
| 60 | 2-methoxy-4-vinylphenol | smoky, clove-like | 2194 | 1317 | 4096 | 128 |
| 61 | decanoic acid ^{h} | soapy, musty | 2265 | 1371 | 32 | — |
| 62 | phenylacetic acid ^{h} | honey-like, | 2556 | 1258 | 128 | 16 |
| | | beeswax-like | | | | |
| 63 | 4-hydroxy-3-methoxy- | vanilla-like, sweet | 2569 | 1404 | 64 | 32 |
| | benzaldehyde ^{h} | | | | | |

^{a}The detected odorants are consecutively numbered.
^{b}The compound is identified by comparing its mass spectra (MS-EI, MS-CI), retention indices on capillaries FFAP and DB-5 as well as the odor quality during sniffing with data of reference compounds.
^{c}Odor quality taken out of the database from the Leibniz-LSB@TUM.
^{d}Retention index on FFAP-column.
^{e}Retention index on DB-5-column.
^{f} Flavor dilution factor determined by AEDA on capillary FFAP.
^{g} No unequivocal mass spectra is obtained. Identification is based on the remaining criteria given in footnote b.
^{h} acidic Fraction.
ⁱ The compound is identified by the odor quality during sniffing.

TABLE 15
Concentrations of important odorants in distillates prepared
from 6 months (6 m) stored roasted low oleic acid peanuts

| | concentration [μg/kg] | | | |
|---|---|---|---|---|
| odor compound | average ₐ | range _{b} | n ^{c} | RSD [%] ^{d} |
| hexanal | 68168 | 62477-71021 | 3 | 7 |
| hexanoic acid | 64121 | 61971-67845 | 3 | 5 |
| acetic acid | 21259 | 20623-22352 | 3 | 5 |
| octanal | 5887 | 5324-6351 | 3 | 9 |
| nonanal | 4974 | 4783-5248 | 3 | 5 |
| pentanoic acid | 4294 | 4035-4537 | 3 | 6 |
| (E)-2-undecenal | 2585 | 2548-2645 | 3 | 2 |
| methylpropanal | 1807 | 1692-1922 | 3 | 9 |
| hydrogen sulfide | 1479 | 1297-1712 | 3 | 14 |
| 2,3,5-trimethylpyrazine | 864 | 840-907 | 3 | 4 |
| 2-methylbutanal | 861 | 858-864 | 2 | 1 |
| 2-methoxy-4-vinylphenol | 669 | 652-687 | 2 | 4 |
| methanethiol | 473 | 431-515 | 3 | 13 |
| 3-methylbutanal | 320 | 310-329 | 3 | 4 |
| 1-octanol | 284 | 278-290 | 3 | 3 |
| 2-methylbutanoic acid | 202 | 198-206 | 2 | 3 |
| 3-methylbutanoic acid | 187 | 186-188 | 3 | 1 |
| furfurylalcohol | 165 | 154-175 | 3 | 6 |
| phenylacetic acid | 159 | 150-169 | 3 | 8 |
| 2,3-diethyl-5- | 102 | 100-103 | 3 | 2 |
| methylpyrazine | | | | |
| furfural | 93.7 | 92.2-95.7 | 3 | 2 |
| phenylacetaldehyde | 91.8 | 86.1-100 | 3 | 8 |
| 2-ethyl-3,5- | 82.3 | 81.4-83.3 | 3 | 2 |
| dimethylpyrazine | | | | |
| 2,3-butanedione | 64.7 | 61.5-67.9 | 2 | 7 |
| dimethyl trisulfide | 37.9 | 37.3-38.5 | 3 | 2 |
| 1-octen-3-one | 35.9 | 35.3-42.4 | 3 | 2 |
| 2-methoxpyhenol | 33.9 | 33.7-34.1 | 3 | 1 |
| 4-hydroxy-2,5-dimethyl- | 28.9 | 28.7-29.1 | 3 | 1 |
| 3(2H)-furanone | | | | |
| 2-propionyl-1-pyrroline | 17.4 | 16.3-18.4 | 3 | 9 |
| 3-(methylthio)-propanal | 15.7 | 15.3-16.0 | 3 | 3 |
| 2,3-pentanedione | 13.6 | 12.8-15.0 | 3 | 9 |
| (Z)-2-nonenal | 13.1 | 10.8-14.7 | 3 | 15 |
| 2-acetylpyrazine | 12.9 | 12.0-13.5 | 3 | 6 |
| 3-hydroxy-4,5-dimethyl- | 12.3 | 12.1-12.5 | 3 | 2 |
| 2(5H)-furanone | | | | |
| 2-isopropyl-3- | 7.71 | 7.45-7.86 | 3 | 3 |
| methoxypyrazine | | | | |
| 2-furfurylthiol | 6.92 | 6.41-7.36 | 3 | 7 |
| 2-isobutyl-3- | 6.78 | 6.66-6.89 | 3 | 2 |
| methoxypyrazine | | | | |
| 2-(sec-butyl)-3- | 4.72 | 4.68-4.80 | 3 | 2 |
| methoxypyrazine | | | | |
| 2-acetyl-1-pyrroline | 1.92 | 1.91-1.92 | 3 | 0 |
| 2-acetyl-(1,4,5,6)- | 1.31 | 1.29-1.33 | 3 | 2 |
| tetrahydropyridine | | | | |
| 2-acetyl-(3,4,5,6)- | 0.59 | 0.55-0.62 | 2 | 9 |
| tetrahydropyridine | | | | |

ₐ Average values are calculated from n determinations.
_{b} The range shows the smallest and the highest concentration measured within n determinations.
^{c} Number of determinations.
^{d} Relative standard deviation (RSD)

TABLE 16
Odor Activity Values of important odorants in 6 months
(6 m) stored roasted low oleic acid peanuts (LOAP)

| odorant | OAV^{a} | OOT (μg/kg)^{b} |
|---|---|---|
| methanethiol | 1314 | 0.36 |
| dimethyl trisulfide | 1264 | 0.03 |
| 2-isopropyl-3-methoxypyrazine | 771 | 0.01 |
| 2-furfurylthiol | 364 | 0.019 |
| 2-propionyl-1-pyrroline | 248 | 0.07 |
| hexanal | 227 | 300 |
| 2-isobutyl-3-methoxypyrazine | 170 | 0.04 |
| hexanoic acid | 139 | 460 |
| methylpropanal | 121 | 15 |
| 2,3-butanedione | 72 | 0.9 |
| acetic acid | 61 | 350 |
| 3-hydroxy-4,5-dimethyl-2(5H)-furanone | 54 | 0.23 |
| 2-ethyl-3,5-dimethylpyrazine | 48 | 1.7 |
| octanal | 42 | 140 |
| 2-acetyl-1-pyrroline | 36 | 0.053 |
| 3-(methylthio)-propanal | 30 | 0.52 |
| 2-methylbutanal | 25 | 34 |
| 3-methylbutanal | 21 | 15 |
| 2-methoxpyhenol | 19 | 1.8 |
| 3-methylbutanoic acid | 17 | 11 |
| 1-octanol | 16 | 18 |
| hydrogen sulfide | 15 | 100 |
| 2,3-diethyl-5-methylpyrazine | 14 | 7.2 |
| pentanoic acid | 11 | 400 |
| 2-(sec-butyl)-3 -methoxypyrazine | 10 | 0.46 |
| nonanal | 8 | 610 |
| 2-methoxy-4-vinylphenol | 7 | 98 |
| phenylacetic acid | 6 | 26 |
| 2,3,5-trimethylpyrazine | 5 | 180 |
| 2-acetyl-(1,4,5,6)-tetrahydropyridine | 4 | 0.32 |
| (Z)-2-nonenal | 4 | 3.6 |
| 2,3-pentanedione | 3 | 4.5 |
| phenylacetaldehyde | 3 | 37 |
| 4-hydroxy-2,5-dimethyl-3(2H)-furanone | 2 | 27 |
| 2-methylbutanoic acid | 2 | 110 |
| 2-acetylpyrazine | <1 | 16 |
| 2-acetyl-(3,4,5,6)-tetrahydropyridine | <1 | 1.2 |
| furfural | <1 | 28000 |
| furfurylalcohol | <1 | 700 |
| 1-octen-3-one | <1 | 61 |
| (E)-2-undecenal | <1 | 7700 |

^{a}Odor Activity Value.
^{b}Odor Threshold in sunflower oil.

Tables 17 and 18 shows selected aroma compounds showing a significant decrease in the concentrations between freshly roasted and stored roasted high oleic acid peanuts and low oleic acid peanuts.

TABLE 17

| | concentration [μg/kg] | | | | |
|---|---|---|---|---|---|
| | | HOAP | | LOAP | |
| odorant | (f) | (6 m) | (1 y) | (f) | (6 m) |
| 2-acetyl-(3,4,5,6)- | 187 | 18.2 | 0.79 | 10.6 | 0.59 |
| tetrahydropyridine | | | | | |
| 2,3-pentanedione | 2759 | 34.7 | 17.3 | 1191 | 13.6 |
| phenylacetaldehyde | 5260 | 69.6 | 44.7 | 4808 | 91.8 |
| 2-acetyl-(1,4,5,6)- | 176 | 3.21 | 2.22 | 129 | 1.31 |
| tetrahydropyridine | | | | | |
| 4-hydroxy-2,5-dimethyl- | 3401 | 106 | 43.7 | 3782 | 28.9 |
| 3(2H)-furanone | | | | | |
| 2-methylbutanal | 4883 | 144 | 95.0 | 3565 | 861 |
| 2,3-butanedione | 2770 | 87.9 | 57.7 | 126 | 64.7 |
| 3-methylbutanal | 2078 | 98.8 | 81.7 | 951 | 320 |
| 2-acetyl-1-pyrroline | 54.5 | 3.25 | 2.83 | 34.1 | 1.92 |
| 2-ethyl-3,5- | 299 | 25.0 | 45.0 | 207 | 82.3 |
| dimethylpyrazine | | | | | |
| 2-methoxy-4-vinylphenol | 2315 | 1425 | 385 | 4910 | 669 |
| 2,3-diethyl-5- | 121 | 110 | 20.8 | 146 | 102 |
| methylpyrazine | | | | | |
| phenylacetic acid | 639 | 99.1 | 146 | 733 | 159 |
| 2-propionyl-1-pyrroline | 36.1 | 15.0 | 8.83 | 32.5 | 17.4 |
| 2-acetylpyrazine | 148 | 82.8 | 64.7 | 138 | 12.9 |

Freshly (f) roasted; 6 months (6 m); 1 year (1 y); high oleic acid peanuts (HOAP); low oleic acid peanuts (LOAP).

TABLE 18

| | concentration [μg/kg] | | | | |
|---|---|---|---|---|---|
| | | | HOAP | | LOAP |
| odorant | (f) | (6 m) | (1 y) | (f) | (6 m) |
| hydrogen sulfide | 7807 | 4941 | 3020 | 6032 | 1479 |
| methanethiol | 901 | 564 | 491 | 571 | 473 |
| dimethyl trisulfide | 9.56 | 29.1 | 9.84 | 4.90 | 37.9 |

Freshly (f) roasted; 6 months (6 m); 1 year (1 y); high oleic acid peanuts (HOAP); low oleic acid peanuts (LOAP).

Although the presently disclosed subject matter and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein may be utilized according to the presently disclosed subject matter. Accordingly, the appended claims are intended to include within their scope such processes, machines, manufacture, compositions of matter, means, methods, or steps.

Patents, patent applications, publications, product descriptions and protocols are cited throughout this application the disclosures of which are incorporated herein by reference in their entireties for all purposes.

What is claimed is:

1. A flavor composition comprising:
a first aroma compound selected from the group consisting of 2-acetyl-(1,4,5,6)-tetrahydropyridine, 2-acetyl-(3,4,5,6)-tetrahydropyridine, 2-acetyl-1-pyrroline, 2-propionyl-1-pyrroline, 2-acetylpyrazine and any combination thereof;
a second aroma compound selected from the group consisting of 2,3-pentanedione, 2,3-butanedione and a combination thereof; and
a third aroma compound selected from the group consisting of phenylacetaldehyde, phenylacetic acid and a combination thereof.

2. The flavor composition of claim 1, wherein the concentration ratio of the first compound to the second compound to the third compound is a:b:c, wherein a ranges from about 3 to about 8, b ranges from about 20 to about 60, and c ranges from about 10 to about 60.

3. The flavor composition of 1 or 2, further comprising:
a fourth aroma compound of 4-hydroxy-2,5-dimethyl-3(2H)-furanone,
a fifth aroma compound selected from the group consisting of 2-methylbutanal, 3-methylbutanal and a combination thereof,
a sixth aroma compound selected from the group consisting of 2-ethyl-3,5-dimethylpyrazine, 2,3-diethyl-5-methylpyrazine and a combination thereof,
a seventh aroma compound of 2-methoxy-4-vinylphenol, and/or
an eighth aroma compound selected from the group consisting of hydrogen sulfide, methanethiol, dimethyl trisulfide, methylpropanal and any combination thereof.

4. The flavor composition of claim 3, wherein the concentration ratio of the first compound to the fourth compound to the fifth compound to the sixth compound to the seventh compound to the eighth compound is a:d:e:f:g:h, wherein a ranges from about 0.1 to about 10, d ranges from about 10 to about 40, e ranges from about 20 to about 90, f ranges from about 1 to about 10, g ranges from about 10 to about 40, and h ranges from about 50 to about 130.

5. A flavor composition comprising hydrogen sulfide, methanethiol, dimethyl trisulfide, and/or methylpropanal.

6. The flavor composition of claim 5, wherein the concentration ratio of hydrogen sulfide, methanethiol, dimethyl trisulfide, methylpropanal is w:x:y:z, wherein w ranges from about 50 to about 100, x ranges from about 5 to about 20, y ranges from about 5 to about 20, and z ranges from about 30 to about 50.

7. The flavor composition of claim 5 or 6, further comprising one or more aroma compounds selected from the group consisting of 2,3-butanedione, methanethiol, 2-acetyl-1-pyrroline, 2-furfurylthiol, 2,3-pentanedione, 2-acetyl-(1,4,5,6)-tetrahydropyridine, 2-propionyl-1-pyrroline, 2-isopropyl-3-methoxypyrazine, dimethyl trisulfide, methylpropanal, 2-ethyl-3,5-dimethylpyrazine, 2-acetyl-(3,4,5,6)-tetrahydropyridine, phenylacetaldehyde, 2-methylbutanal, 3-methylbutanal, 2-isobutyl-3-methoxypyrazine, 3-(methylthio)-propanal, 4-hydroxy-2,5-dimethyl-3(2H)-furanone, hydrogen sulfide, acetic acid, 3-hydroxy-4,5-dimethyl-2(5H)-furanone, phenylacetic acid, 2-methoxy-4-vinylphenol, 2,3-diethyl-5-methylpyrazine, 1-octanol, 2-(sec-butyl)-3-methoxypyrazine, 2-methoxpyhenol, 2-acetylpyrazine, 2,3,5-trimethylpyrazine, 3-methylbutanoic acid, nonanal, octanal, 2-methylbutanoic acid, (Z)-2-nonenal, hexanal, hexanoic acid and pentanoic acid.

8. A flavor composition comprising one or more compound selected from the group consisting of 2,3-butanedione, methanethiol, 2-acetyl-1-pyrroline, 2-furfurylthiol, 2,3-pentanedione, 2-acetyl-(1,4,5,6)-tetrahydropyridine, 2-propionyl-1-pyrroline, 2-isopropyl-3-methoxypyrazine, dimethyl trisulfide, methylpropanal, 2-ethyl-3,5-dimethylpyrazine, 2-acetyl-(3,4,5,6)-tetrahydropyridine, phenylacetaldehyde, 2-methylbutanal, 3-methylbutanal, 2-isobutyl-3-methoxypyrazine, 3-(methylthio)-propanal, 4-hydroxy-2,5-dimethyl-3(2H)-furanone, hydrogen sulfide, acetic acid, 3-hydroxy-4,5-dimethyl-2(5H)-furanone, phenylacetic acid, 2-methoxy-4-vinylphenol, 2,3-diethyl-5-methylpyrazine, 1-octanol, 2-(sec-butyl)-3-methoxypyrazine, 2-methoxpyhenol, 2-acetylpyrazine, 2,3,5-trimethylpyrazine, 3-methylbutanoic acid, nonanal, octanal, 2-methylbutanoic acid and (Z)-2-nonenal.

9. The flavor composition of claim 8, wherein the one or more compound has an odor activity value (OAV) of no less than 1 in freshly roasted peanuts.

10. The flavor composition of claim 8, wherein the one or more compound is 2,3-butanedione, methanethiol, 2-acetyl-1-pyrroline, 2-furfurylthiol, 2,3-pentanedione, 2-acetyl-(1,4,5,6)-tetrahydropyridine, 2-propionyl-1-pyrroline, 2-isopropyl-3-methoxypyrazine, dimethyl trisulfide, methylpropanal, 2-ethyl-3,5-dimethylpyrazine, 2-acetyl-(3,4,5,6)-tetrahydropyridine, phenylacetaldehyde, 2-methylbutanal, 3-methylbutanal, 2-isobutyl-3-methoxypyrazine, 3-(methylthio)-propanal, and/or 4-hydroxy-2,5-dimethyl-3(2H)-furanone.

11. The flavor composition of claim 10, wherein the one or more compound has an odor activity value (OAV) of no less than 100 in freshly roasted peanuts.

12. The flavor composition of claim 8, wherein the one or more compound is 2,3-butanedione, methanethiol, 2-acetyl-1-pyrroline, 2-furfurylthiol, 2,3-pentanedione, 2-acetyl-(1,4,5,6)-tetrahydropyridine, 2-propionyl-1-pyrroline, and/or 2-isopropyl-3-methoxypyrazine.

13. The flavor composition of claim 8, wherein the one or more compound has an odor activity value (OAV) of no less than 500 in freshly roasted peanuts.

14. The flavor composition of any one of claims 1-13, wherein the composition further comprises an edible carrier.

15. The flavor composition of any one of claims 1-14, wherein the aroma compounds are present at a total concentration of from about 0.0001% to about 20% w/w in the flavor composition.

16. The food produce of any one of claims 1-14, wherein the flavor composition is present at a concentration of from about 1 μM to about 100 mM in the food product.

17. The food produce of any one of claims 1-14, wherein the flavor composition is present at a concentration of from about 0.01 ppm to 1,000 ppm in the food product.

18. The flavor composition of any one of claims 1-17, wherein the edible carrier is a water/oil mixture.

19. The flavor composition of any one of claims 1-18, wherein the flavor composition enhances a roasted peanut flavor.

20. A food product comprising a base food and a flavor composition of any one of the preceding claims.

21. The food produce of claim 20, wherein the flavor composition is present at a concentration of from about 0.01 ppb to 1,000 ppb in the food product.

22. The food produce of claim 20, wherein the flavor composition is present at a concentration of from about 0.01 ppm to 1,000 ppm in the food product.

23. The food produce of claim 20, wherein the flavor composition is present at a concentration of from about 0.0001% to about 1% w/w in the food product.

24. The food produce of any one of claims 20-23, wherein the base food comprises a peanut.

25. The food produce of claim 24, wherein the peanut is a high oleic acid peanut (HOAP).

26. The food produce of claim 24, wherein the peanut is a low oleic acid peanut (LOAP).

27. The food produce of any one of claims 20-26, wherein the food product is a human food or a pet food.

28. A method of producing a food product, comprising admixing a base food with an effective amount of a flavor composition of any one of claims 1-19.

29. A method of enhancing a roasted peanut flavor of a food product, comprising admixing a food product with an effective amount of a flavor composition of any one of claims 1-19.
